(19) United States
(12) Patent Application Publication
(10) Pub. No.: US 2015/0153997 A1
(43) Pub. Date: Jun. 4, 2015

(54) ELECTRONIC PAD APPARATUS, DATA MANAGEMENT APPARATUS AND ELECTRONIC PAPER

(71) Applicant: CASIO COMPUTER CO., LTD., Tokyo (JP)

(72) Inventors: Junichi YOSHIDA, Hamura-shi (JP); Hideo SUZUKI, Tokyo (JP)

(73) Assignee: CASIO COMPUTER CO., LTD., Tokyo (JP)

(21) Appl. No.: 14/615,807

(22) Filed: Feb. 6, 2015

Related U.S. Application Data
(63) Continuation of application No. PCT/JP2013/071898, filed on Aug. 7, 2013.

(30) Foreign Application Priority Data
Aug. 8, 2012 (JP) 2012-176079
Sep. 3, 2012 (JP) 2012-193318

(51) Int. Cl. G06F 3/14; G09F 9/37

(52) U.S. Cl. CPC G06F 3/1462; G09F 9/372

(57) ABSTRACT

When it is detected that electronic paper is mounted on an electronic pad, the electronic paper, on which content is displayed, is transmitted to an electronic paper management server on a cloud system and registered to correspond to a pad ID of the electronic pad, a paper ID of the electronic paper and content display data that is being displayed. Then, when it is detected that electronic paper is newly mounted, if the combination of the pad ID of the electronic pad and the paper ID of the electronic paper is registered in the electronic paper management server, the content display data that is registered to correspond to the combination of the electronic pad ID and the electronic paper ID is redisplayed on the electronic paper received from the management server.

### CROSS-REFERENCE TO RELATED APPLICATIONS

This application is a Continuation Application of PCT Application No. PCT/JP2013/071898, filed Aug. 7, 2013 and based upon and claiming the benefit of priority from Japanese Patent Applications No. 2012-176079, filed Aug. 8, 2012; and No. 2012-193318, filed Sep. 3, 2012, the entire contents of all of which are incorporated herein by reference.

### BACKGROUND OF THE INVENTION

1. Field of the Invention

The present invention relates to an electronic pad apparatus and a data management apparatus for recording and displaying desired information on electronic paper using a paper-like nonvolatile display unit and also relates to the electronic paper.

2. Description of the Related Art

In recent years, a paper-like nonvolatile display unit called electronic paper has been developed. Electronic paper has a display surface for displaying and holding images with no power supply and is thin and flexible, although not as thin or flexible as actual paper. Being supplied with a power supply voltage, the electronic paper can write and erase an image and display and hold various content items, such as text and images (refer to Jpn. Pat. Appln. KOKAI Publications Nos. 2006-039834, 2001-312227 and 2003-058081, for example).

Applicant filed a patent application for an electronic paper recording apparatus capable of handwriting content on electronic paper mounted on a pad and thus displaying the handwritten content on the electronic paper (refer to Jpn. Pat. Appln. KOKAI Publication No. 2007-323365, for example).

The electronic paper recording apparatus is a client/server system in which the combination of a pad and paper is a thin client. In this system, screen data of a default corresponding to the combination of a pad and paper is generated and stored on a server in advance (virtual paper client). If the paper is mounted on the pad, the screen data can be read from the server and displayed on the paper. When handwriting is performed on the screen data on the paper, the screen data including the handwriting can be updated on the server.

However, the above prior art electronic paper recording apparatus is based on the premise that the initial screen data of a default corresponding to the combination of a pad and paper is generated and stored in the server in advance. It is only handwritten data added to the initial screen data that can be updated and stored on the server side. Thus, the initial screen data cannot be registered arbitrarily on the user side.

Furthermore, in the above prior art electronic paper recording apparatus, screen data including handwritten data needs to be stored in the server for each of the combinations of a pad and paper. If the combinations increase in number, the huge amount of data will be stored in the server.

If the handwritten data added to the screen data includes important comments and secret comments, the handwritten comments will be stored in the server as screen data, which is very likely to cause a security problem.

### BRIEF SUMMARY OF THE INVENTION

It is an object of the present invention to provide an electronic pad apparatus and a data management apparatus which are capable of displaying user arbitrary data on electronic paper, and registering the displayed data in a server to correspond to the combination of the electronic paper with an electronic pad and redisplaying it easily

It is another object of the present invention to provide an electronic pad apparatus and electronic paper which are capable of redisplaying added data on content displayed on the electronic paper in accordance with the electronic pad, without causing any data capacity problem or security problem on the server.

An electronic pad apparatus on which electronic paper is mounted detachably, comprising:

A paper detection unit for detecting that the electronic paper is mounted; a display data registration unit for transmitting a pad ID of the electronic pad apparatus, a paper ID of the electronic paper and content display data to an externally-connected server unit and registering the pad ID, the paper ID and the content display data to correspond to one another, the content display data being displayed on the electronic paper detected by the paper detection unit; a data registration determination unit for determining whether the content display data corresponding to the pad ID and the paper ID is registered in the server unit when the paper detection unit detects that electronic paper is newly mounted; a registered data reception unit for, when the data registration determination unit determines that the content display data corresponding to the pad ID and the paper ID is registered in the server unit, receiving the content display data from the server unit; and a registered data display control unit for displaying the content display data received by the registered data reception unit on the newly mounted electronic paper.

A data management apparatus which manages display information of electronic paper detachably mounted on an electronic pad apparatus, the data management apparatus comprising:

a display information registration unit for registering a pad ID of the electronic pad apparatus, a paper ID of the electronic paper and content display data displayed on the electronic paper to correspond to one another; a data reception unit for receiving the pad ID of the electronic pad apparatus and the paper ID of the electronic paper from the electronic pad apparatus; a new registration unit for when the display information registration unit does not register a combination of the pad ID of the electronic pad apparatus and the paper ID of the electronic paper which are received by the data reception unit, new registration content display data received from the electronic pad apparatus in the display information registration unit to correspond to the combination of the pad ID and the paper ID; an update registration unit for when the display information registration unit registers a combination of the pad ID of the electronic pad apparatus and the paper ID of the electronic paper which are received by the data reception unit and when the content display data registered to correspond to the combination of the pad ID and the paper ID differs from the content display data received from the electronic pad apparatus, updating the registered content display data to the received content display data and registering the updated content display data; and a data transmission unit for when the display information registration unit registers a combination of the pad ID of the electronic pad apparatus and the paper ID of the electronic paper which are received by the data reception unit and when the content display data corresponding to the pad ID and the paper ID is not received, reading content display data registered to correspond to the pad ID and the paper ID and transmitting the content display data as data to be redisplayed on the electronic paper mounted on the electronic pad apparatus.

An electronic pad apparatus on which electronic paper is mounted detachably, comprising:

a paper detection unit for detecting that the electronic paper is mounted; an additional overlay display control unit for laying and displaying data corresponding to a user operating position as additional data on display data of arbitrary content displayed on the electronic paper detected by the paper detection unit; an additional data storage unit for storing the additional data laid and displayed on the display data displayed on the electronic paper by the additional overlay display control unit and its positional information to correspond to a content ID of the display data; an additional presence/absence determination unit for determining whether the additional data storage unit stores additional data corresponding to the content ID of the display data displayed on the electronic paper when the paper detection unit detects that electronic paper is newly mounted; and an additional overlay redisplay control unit for when the additional presence/absence determination unit determines that additional data corresponding to the content ID of the display data is stored, reading the additional data and the positional information and laying and redisplaying the additional data and the positional information in a corresponding position on the display data displayed on the electronic paper.

Electronic paper which is detachably mounted on an electronic pad to displaying display data of arbitrary content, the electronic paper comprising:

a pad detection unit for detecting that the electronic paper is mounted on the electronic pad; an additional overlay display control unit for laying and displaying data corresponding to a user operating position as additional data on the display data of arbitrary content displayed on the electronic paper which is mounted on the electronic pad and detected by the pad detection unit; an additional data storage unit for storing the additional data laid and displayed on the display data by the additional overlay display control unit and its positional information to correspond to the pad ID of the electronic pad detected by the pad detection unit; an additional presence/absence determination unit for determining whether the additional data storage unit stores the additional data corresponding to the pad ID of the electronic pad when the pad detection unit detects that electronic paper is newly mounted on the electronic pad; and an additional overlay redisplay control unit for when the additional presence/absence determination unit determines that the additional data corresponding to the pad ID of the electronic pad is stored, reading the additional data and the positional information and laying and redisplaying the additional data and the positional information in a corresponding position on the display data displayed on the electronic paper.

According to the present invention, user arbitrary data can be displayed on the electronic paper, and the displayed data can be registered in the server to correspond to the combination of the electronic paper with the electronic pad and redisplayed easily.

Furthermore, according to the present invention, added data is redisplayed on content displayed on the electronic paper in accordance with the electronic pad, without causing any data capacity problem or security problem on the server.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a configuration of an electronic paper recording apparatus (single-sided type) 10A;

FIG. 2 shows a configuration of an electronic paper recording apparatus (double-sided type) 10B;

FIG. 3 shows a configuration of electronic paper in the electronic paper recording apparatus;

FIG. 4 shows a configuration of an electronic pad in the electronic paper recording apparatus;

FIG. 5 shows a configuration of an electromagnetic induction unit (flat type);

FIG. 6 shows a configuration of an electromagnetic induction unit (convex type);

FIG. 7 is a block diagram showing a configuration of an electronic circuit of the electronic paper recording apparatus;

FIG. 8 shows an electronic paper management table 54 stored and managed in an information storage unit 30;

FIG. 9 is a block diagram showing an example of a configuration when electronic paper recording apparatuses 10B is used;

FIG. 10 shows an electronic paper management table (server) 62;

FIG. 11 is a flowchart showing a process of an electronic pad (part 1);

FIG. 12 is a flowchart showing a process of the electronic pad (part 2);

FIG. 13 is a flowchart showing a process of an electronic paper management server 53;

FIG. 14 is an illustration of a specific usage pattern of the electronic paper recording apparatus;

FIG. 15 shows a handwriting data storage unit 21H; and

FIG. 16 is a flowchart showing a process of electronic paper 11B.

### DETAILED DESCRIPTION OF THE INVENTION

Embodiments of the present invention will be described below with reference to the accompanying drawings.

### First Embodiment

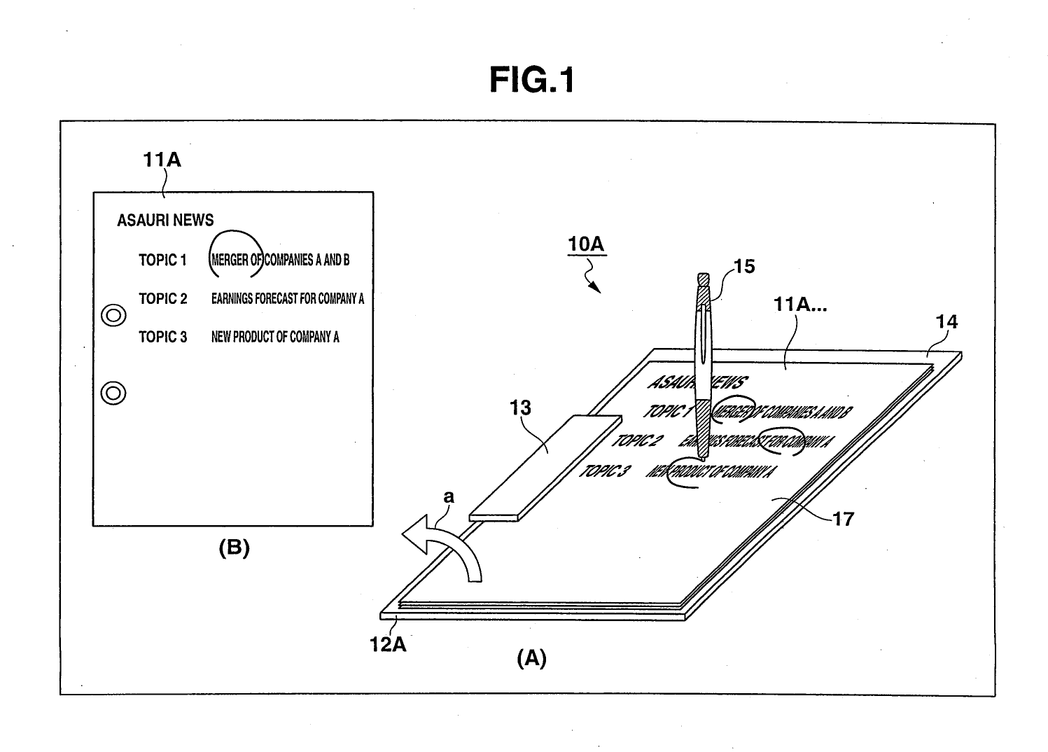

FIG. 1 shows a configuration of an electronic paper recording apparatus (single-sided type) 10A according to a first embodiment of the present invention. In FIG. 1, (A) is a perspective view of the electronic paper recording apparatus and (B) is a front view of a single electronic paper (single-sided type) 11A pulled out of the apparatus.

Electronic paper recording apparatus (single-sided type) 10A comprises a plurality of electronic papers (single-sided type) 11A each having a nonvolatile display unit 17 on its surface and an electronic pad (single-sided type) 12A on which the plurality of electronic papers 11A are stacked one on top of another. Electronic papers 11A each have the middle of its left side clipped and bound by a single-sided binder unit 13 provided in the middle of the left side of electronic pad 12A.

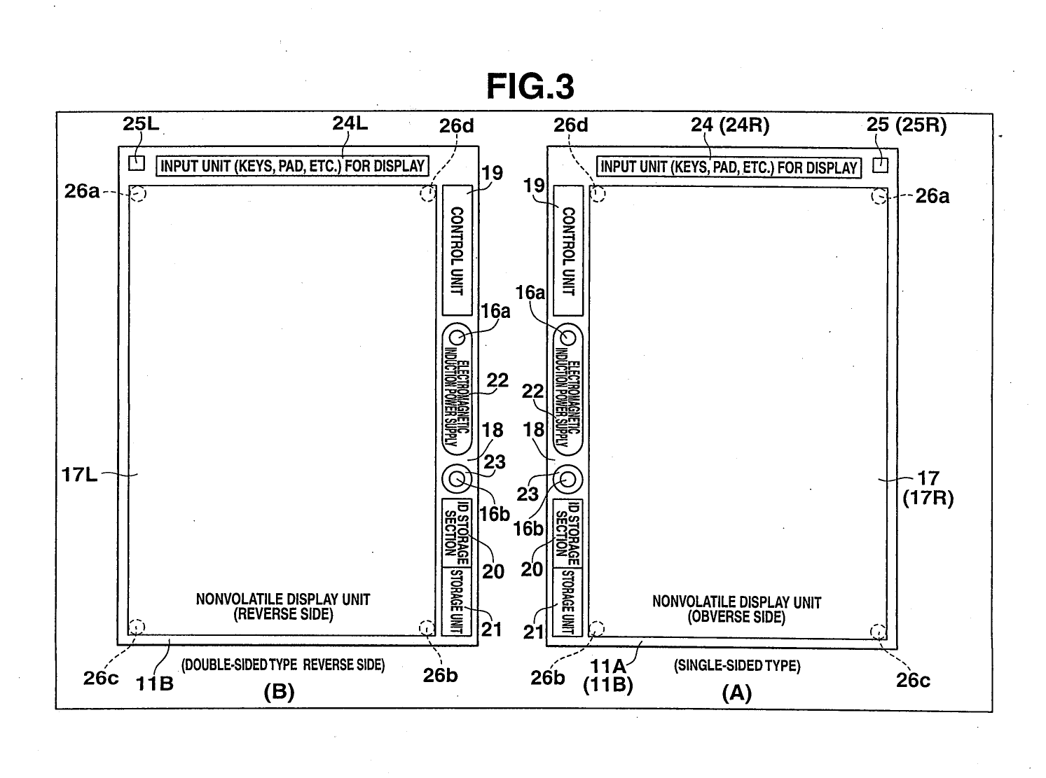

Electronic pad 12A includes, for example, an electromagnetic induction tablet 14 to correspond to the mounting face of electronic paper 11A at the surface of the pad. With the tablet 14, the coordinates corresponding to the position of handwriting with an electronic pen 15 on the uppermost electronic paper 11A is detected. Then, a display storage unit built in electronic paper 11A stores display data corresponding to the detected coordinates of the handwriting position, or display data of different content items acquired from an external information providing apparatus, via a noncontact power supply means and a communication means (FIGS. 3 to 6) which are provided using the binder unit 13 and which will be described later. Then, the nonvolatile display unit 17 of electronic paper 11A carries out a display operation.

The nonvolatile display unit 17 of electronic paper 11A is so configured that, for example, black particles positively charged and white particles negatively charged are sealed alternately in a matrix between transparent electrode plates. Black display is achieved by charging one electrode plate negatively and white display is achieved by charging one electrode plate positively. The electrode plate is charged with the polarity of the voltage last applied to the plate. The display is retained with no power supply.

This enables not only the display data externally input via electronic pad 12A and its binder unit 13 to be displayed on electronic paper 11A, but also the data handwritten directly with the electronic pen 15 to be displayed. Moreover, after removing electronic paper 11A from electronic pad 12A as shown by arrow a in (B) of FIG. 1, it can be treated as if it were an ordinary sheet of paper.

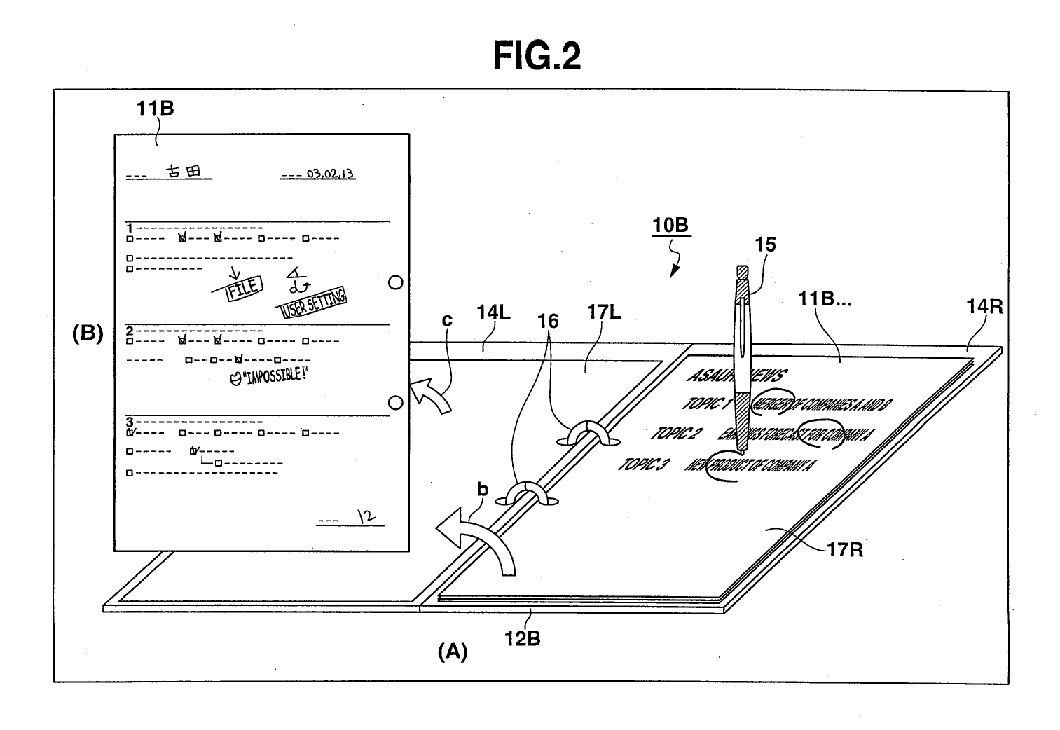

FIG. 2 shows a configuration of an electronic paper recording apparatus (double-sided type) 10B according to the first embodiment. In FIG. 2, (A) is a perspective view of the electronic paper recording apparatus and (B) is a front view of the backside of a single electronic paper (double-sided type) 11B pulled out of the apparatus.

A plurality of electronic papers (double-sided type) 11B used in electronic paper recording apparatus (double-sided type) 10B each include nonvolatile display units 17R and 17L, as described above, on its obverse side and reverse side, respectively. A two-page spread binder unit 16 provided in the middle of a two-page spread electronic pad 12B binds the plurality of electronic papers together in such a manner that the binder unit 16 passes through an end portion of each electronic paper.

The two-page spread electronic pad 12B includes, for example, electromagnetic induction tablets 14R and 14L on the mounting face of electronic paper 11B on each of the right and left parts of the two-page spread. Each of tablets 14R and 14L detects the coordinates corresponding to the handwriting position on the obverse side of the top right part of electronic paper 11B and on the reverse side of the top left part of electronic paper 11B with the electronic pen 15.

Then, a display storage unit built in electronic paper 11B stores display data corresponding to the detected coordinates of the handwriting position on each of the obverse side and reverse side, or display data of different content items acquired from an external information providing apparatus, via a noncontact power supply means and a communication means (FIGS. 3 to 6) which are provided to correspond to the two-page spread binder unit 16 and which will be described later. Then, the nonvolatile display units 17R and 17L on both sides of electronic paper 11B carry out a display operation.

This enables not only the display data externally input via electronic pad 12B and its two-page spread binder unit 16 to be displayed on the obverse and reverse sides of electronic paper (double-sided type) 11B, but also the data handwritten directly with the electronic pen 15 to be displayed. Moreover, if electronic paper 11B is removed from electronic pad 12B as shown by arrow c in (B) of FIG. 2, it can be treated as if it were an ordinary sheet of paper with an obverse side and reverse side.

FIG. 3 shows a configuration of electronic papers 11A and 11B in electronic paper recording apparatuses 10A and 10B. In FIG. 3, (A) is a configuration diagram of electronic paper (single-sided type) 11A when viewed from the obverse side and (B) is a configuration diagram of electronic paper (double-sided type) 11B when viewed from the reverse side.

The configuration of electronic paper (single-sided type) 11A viewed from the obverse side is the same as that of electronic paper (double-sided type) 11B.

Nonvolatile display units (obverse side) 17 (17R) and (reverse side) 17L are provided in almost all the middle areas of electronic papers 11A and 11E, respectively. Moreover, a bind-in unit 18 includes a control unit 19 composed of a flexible IC chip, an ID storage section 20 for storing separate electronic paper IDs, and a (information) storage unit 21 for storing display data in such a manner that they are common to the obverse and reverse sides of each of the electronic papers.

Furthermore, a noncontact electromagnetic induction power supply unit 22 is built into the surrounding area of one binder through-hole 16a made in the middle of the bind-in unit 18 in such a manner that the power supply unit 22 is common to both the obverse side and reverse side. Moreover, a noncontact communication unit 23 is built into the surrounding area of the other binder through-hole 16b in such a manner that the communication unit 23 is common to both the obverse side and reverse side.

Furthermore, input units 24 (24R) and 24L using a key, a touch pad or the like are provided in the upper parts of the obverse sides of electronic papers 11A and 11B and in the upper part of the reverse side of electronic paper 11E. Overlap sensors 25 (25R) and 25L using photo sensors are provided at the end of the upper part of the paper opposite to the bind-in unit 18.

Then, calibration pointers 26a to 26d for detecting a displacement of the mounting position of electronic papers 11A and 11B from electronic pad tablets 14 (14R) and 14L are built into their respective four corners of the nonvolatile display units (obverse side) 17 (17R) and (reverse side) 17L of electronic papers 11A and 11B in such a manner that the pointers 26a to 26d are common to both the obverse side and reverse side of each of the electronic papers.

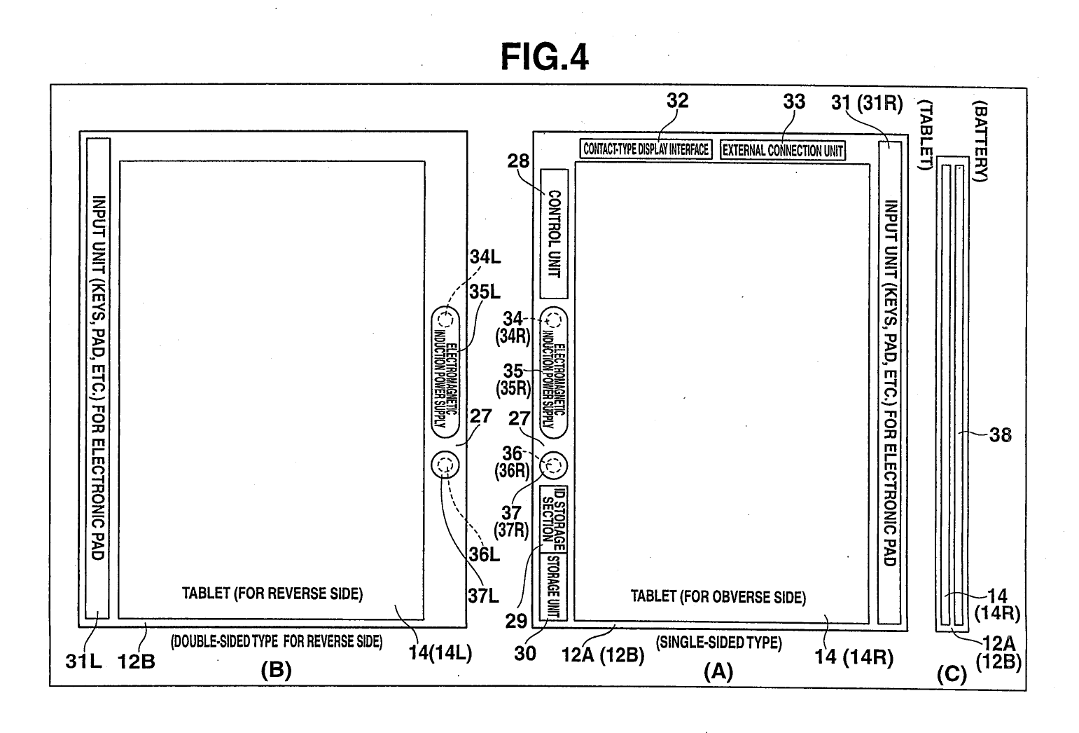

FIG. 4 shows a configuration of electronic pads 12A and 12B in electronic paper recording apparatuses 10A and 10B. In FIG. 4, (A) is a configuration diagram of electronic pad (single-sided type) 12A when viewed from the front side, (B) is a configuration diagram of the left side of the two-page spread electronic pad 12B, and (C) is a vertical cross-sectional view of (the right side of) electronic pads 12A and 12B.

The configuration of electronic pad (single-sided type) 12A viewed from the front is the same as that of the two-page spread electronic pad 12B when viewed from the right side.

Tablets 14 (14R) and 14L of, for example, an electromagnetic induction type are provided in almost all the middle areas of electronic pads 12A and 12B. Moreover, a paper bind-in unit 27 includes a control unit 28 composed of an IC chip, an ID storage section 29 for storing separate electronic pad IDs, and a (information) storage unit 30 for storing display data for electronic papers 11A and 11B.

Furthermore, pad input units 31 (31R) and 31L using a key, a touch pad or the like are provided at the right ends of electronic pads 12A and 12B and at the left end of electronic pad 12B, respectively. Moreover, at the top, there are provided a contact-type display interface 32 for enabling connecter connection of a display unit always needing power supply, such as an LCD monitor, and an external connection unit 33 for connecting with an external communication network, a server computer on the communication network or the like.

Furthermore, electromagnetic induction power supply units 35 (35R) and 35L are built into the central part of the paper bind-in unit 27 which corresponds to the binder position. There are provided power supply cores 34 (34R) and 34L for achieving noncontact power supply to electronic papers 11A and 11B by electromagnetic induction from the electromagnetic induction power supply units 35 (35R) and 35L.

In addition, communication units 37 (37R) and 37L are built in the central part of the paper bind-in unit 27 which corresponds to the binder position. There are provided communication cores 36 (36R) and 36L for achieving noncontact communication with electronic papers 11A and 11B by electromagnetic induction from the communication units 37 (37R) and 37L.

Electronic pads 12A and 12B include a rechargeable battery 38, for example. The battery 38 supplies electric power to tablets 14 (14R) and 14L, control unit 28, ID storage section 29, storage unit 30, pad input units 31 (31R) and 31L and an external display unit connected via the contact-type display interface 32. At the same time, the electromagnetic induction power supply units 35 (35R) and 35L supply electric power via the power supply cores 34 (34R) and 34L to electronic papers 11A and 11B mounted on electronic pads 12A and 12B in a noncontact manner.

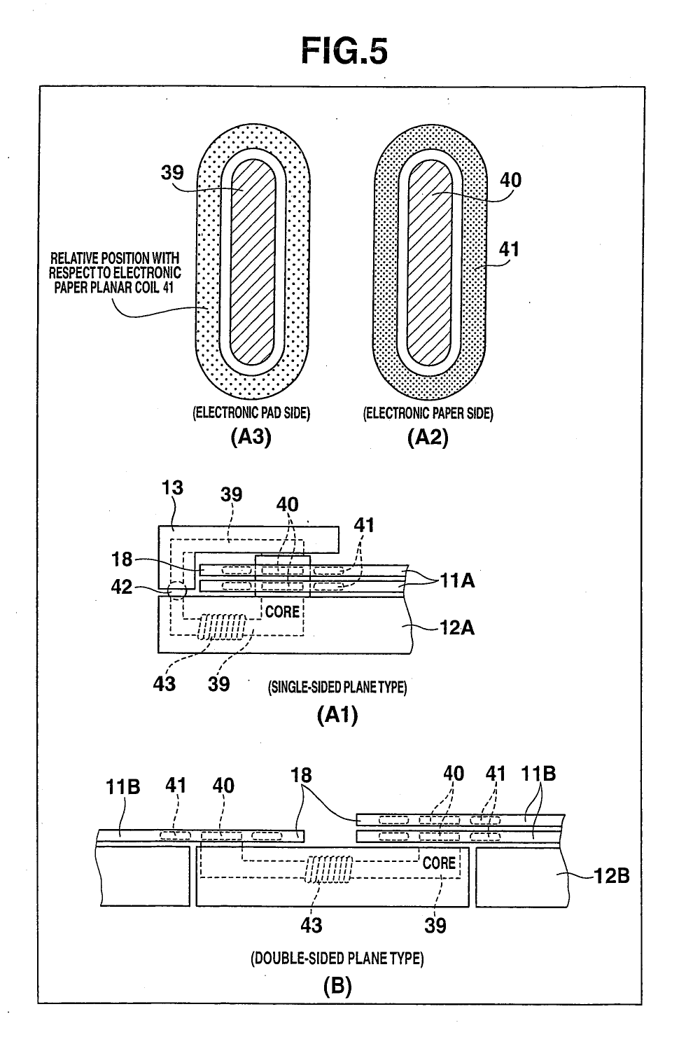

FIG. 5 shows a configuration of an electromagnetic induction unit (flat type) for supplying electric power to and making a communication connection with electronic papers 11A and 11B provided to correspond to the binder units 13 and 16 of electronic pads 12A and 12B in electronic paper recording apparatuses 10A and 10B.

The electromagnetic induction unit (flat type) supplies electric power to and makes a communication connection with the electromagnetic induction power supply unit 22 and communication unit 23 of the bind-in unit 18 of each of electronic papers 11A and 11B which has neither of the binder through-holes 16a and 16b (FIG. 3). In both of electronic papers (single-sided type) 11A and (double-sided type) 11B, an in-paper core 40 is built in a position corresponding to the exposed tip face of a pad-side core 39 provided in the electromagnetic induction power supply units 35 (35R) and 35L and communication units 37 (37R) and 37L of electronic pads 12A and 12B. Then, a signal drawing planar coil 41 is built in so as to surround the in-paper core 40.

In the case of the electromagnetic induction unit of electronic pad (single-sided type) 12A shown in (A1) of FIG. 5, the pad-side core 39 is extended into the binder unit 13 which interfiles electronic paper (single-sided type) 11A to combine with the in-paper core 40 of electronic paper (single-sided type) 11A so that the flux loop of magnetic lines may be formed with low loss. In (A1) of FIG. 5, reference numeral 42 indicates a hinge which has binding force in the binder unit 13.

Specifically, when the in-paper core 40 is provided in the bind-in unit 18 of electronic paper (single-sided type) 11A, the magnetic resistance between the paper and the pad-side core 39 becomes lower via the in-paper core 40 than when the in-paper core is not provided, reducing the leakage flux, which allows a flux loop to pass through smoothly and be formed. The power supply energy signals output from the electromagnetic induction power supply units 35 (35R) and 35L of electronic pads 12A and 12B and the communication signals transmitted from the communication units 37 (37R) and 37L pass through the pad-side coil 43 and pad-side core 39 and are transmitted efficiently from the in-paper core 40 of electronic papers 11A and 11B to the paper-side planar coil 41. Then, electric power is supplied to the electromagnetic induction power supply unit 22. The signal is received by the communication unit 23.

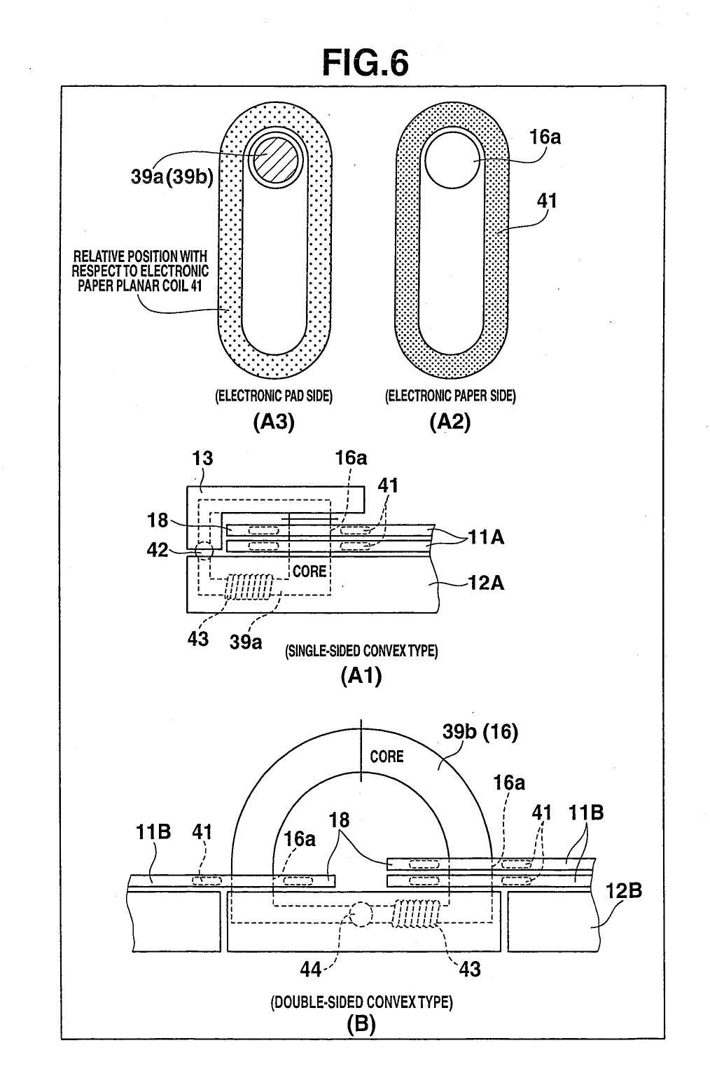

FIG. 6 shows a configuration of an electromagnetic induction unit (convex type) for supplying electric power to and making a communication connection with electronic papers 11A and 11B provided to correspond to the binder units 13 and 16 of electronic pads 12A and 12B in electronic paper recording apparatuses 10A and 10B.

The electromagnetic induction unit (convex type) supplies electric power to and makes a communication connection with the electromagnetic induction power supply unit 22 and communication unit 23 of the bind-in unit 18 in electronic papers 11A and 11B which has binder through-holes 16a and 16b (FIG. 3). As shown in (A1) of FIG. 6, in the case of electronic paper (single-sided type) 11A, a binder convex core 39a provided to correspond to the electromagnetic induction power supply unit 35 and communication unit 37 of electronic pad (single-sided type) 12A is inserted into and locked in the binder through-holes 16a and 16b in the bind-in unit 18 of electronic paper (single-sided type) 11A, thereby interfiling electronic paper (single-sided type) 11A.

As shown in (B) of FIG. 6, in the case of electronic paper (double-sided type) 11B, a binder convex ring-shaped core 39b (16) provided to correspond to the electromagnetic induction power supply unit 35 and communication unit 37 of electronic pad (double-sided type) 12B is inserted into and locked in the binder through-holes 16a and 16b in the bind-in unit 18 of electronic paper (double-sided type) 11B, thereby interfiling electronic paper (double-sided type) 11B. In (B) of FIG. 6, reference numeral 44 indicates a hinge which has binding force in the two-page spread binder unit 16 (39b).

In the case of the electromagnetic induction units of electronic pads 12A and 12B for electronic papers 11A and 11B having the binder through-holes 16a and 16b shown in FIG. 6, since a toroidal core passing through the binder through-holes 16a and 16b of electronic papers 11A and 11B is formed by either the binder convex core 39a or binder convex ring-shaped core 39b in both one electronic pad (single-sided type) 12A and the other electronic pad (double-sided type) 12B, the flux loop of magnetic lines is formed with lower loss.

Specifically, the power supply energy signals output from the electromagnetic induction power supply units 35 (35R) and 35L of electronic pads 12A and 12B and the communication signals transmitted from the communication units 37 (37R) and 37L pass through the pad-side coil 43 and binder convex core 39a or binder convex ring-shaped core 39b and are transmitted efficiently from the paper-side planar coils 41 of electronic papers 11A and 11B. Then, electric power is supplied to the electromagnetic induction power supply unit 22. The signal is received by the communication unit 23.

When handwriting is done with the electronic pen 15 on electronic paper 11A (11B) mounted on the tablet 14 of electronic pad 12A (12B), the coordinates of the handwriting position with the electronic pen 15 are detected by the tablet 14 of electronic pad 12A (12B).

At this time, the deviation of the coordinates of, the mounting position of electronic paper 11A (118) from those of its determined mounting position is calculated and detected by the control unit 28 of electronic pad 12A (12B) by detecting the coordinates of the position of each of the calibration pointers 26a to 26d composed of electromagnetic induction coils with the tablet 14.

By doing this, the coordinates detected by the tablet 14 of electronic pad 12A (12B) as a result of the writing operation with the electronic pen 15 on electronic paper 11A (11B) are corrected according to the calculated and detected amount of deviation from the determined mounting position on electronic paper 11A (11B). According to the corrected writing coordinates, display data on a writing locus is stored from the communication unit 23 of electronic paper 11A (11B) into the (information) storage unit 21. Then, the handwriting data is displayed on the nonvolatile display unit 17.

For example, in a state where a single electronic paper 11B (A) is opened on the left tablet 14L of electronic pad (double-sided type) 12B and two electronic papers 11B are laid one on top of another in the order of (C)→(B) on the right tablet 14R, a backside overlap sensor 25L of electronic paper 11B (A) on the left tablet 14L detects received light and determines that “there is no overlap” and, at the same time, the coordinates of the electronic paper are detected on tablet 14L according to the calibration pointers 26a to 26d. It is therefore determined that electronic paper 11B (A) is valid (active) on the left face of electronic pad (double-sided type) 12B.

Moreover, with respect to the two electronic papers 11B (C) and (B) laid one on top of another on the right tablet 14R, both of electronic papers 11B (C) and (B) are detected by tablet 14R according to the calibration pointers 26a to 26d. At the same time, the obverse-side overlap sensor 25R of electronic papers 11B (B) detects received light and it is determined that “there is no overlap.” Electronic paper 11B (B) is determined to be valid (active) on the right face of electronic pad (double-sided type) 12B.

If there is electronic paper 11B standing straight, the obverse and reverse side overlap sensors 25R and 25L detect received light and determine that “there is no overlap” and, at the same time, the electromagnetic induction signals from the calibration pointers 26a to 26d are detected at neither the right tablet 14R nor the left tablet 14L of electronic pad 12B. It is therefore determined that electronic paper 11B is invalid (inactive).

Accordingly, in the control unit 28 of electronic pad 12B, the detection of the presence or absence of an overlap by the obverse and reverse side overlap sensors 25R and 25L, the detection of the presence or absence of activation by the calibration pointers 26a to 26d, each paper size, and others are acquired and managed so as to correspond to the IDs (A), (B) and (C) of the respective electronic papers 11B which makes communication contact in a noncontact manner via the electromagnetic induction unit. This enables the control unit to distinguish the valid (active) electronic paper 11B on the right and left tablets 14R and 14L and further enables the display data of different content items acquired from an externally connected information terminal, the handwriting data with the electronic pen 15 detected by the right and left tablets 14R and 14L, character data input by the input units 31L and 31R, or the like to be displayed on the nonvolatile display units 17R and 17L which have the ID of the valid (active) electronic paper 11B via the electromagnetic induction unit.

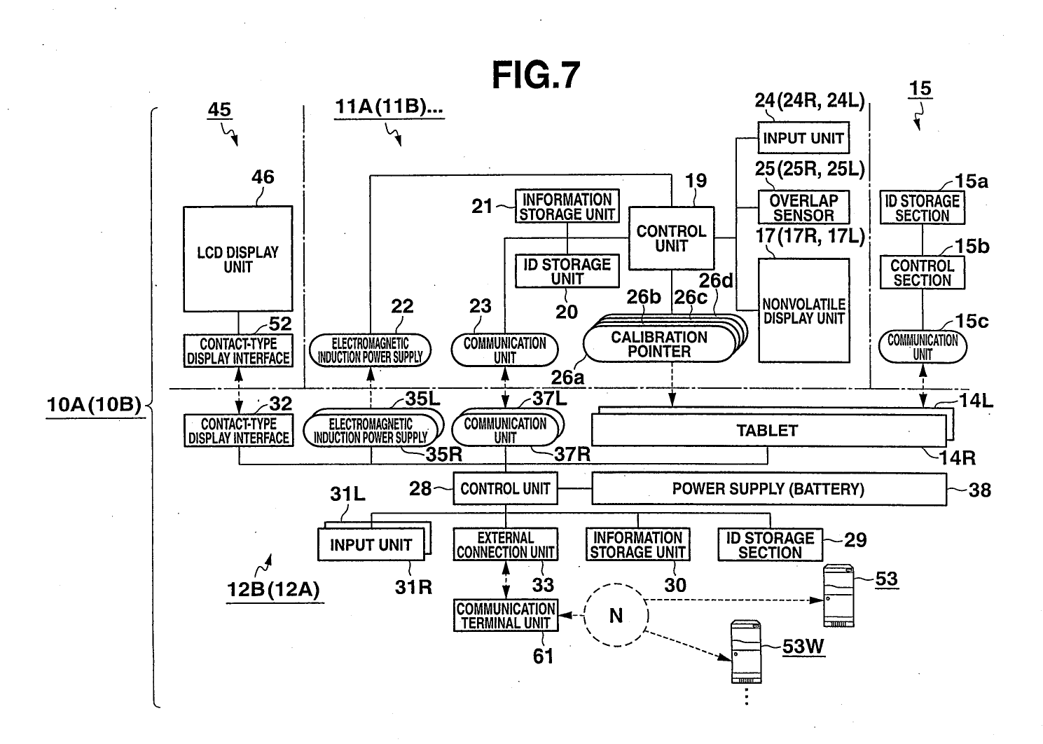

FIG. 7 is a block diagram showing a configuration of an electronic circuit into which electronic paper recording apparatuses 10A and 10B are incorporated as terminals of a cloud computing system on a network N.

According to the electronic circuit, a Web browser can be incorporated into electronic pad 12B (12A) to display on electronic paper 11A (11B) display data of arbitrary content acquired selectively from an information providing server 53W on the network N. The display data can be registered and managed by an electronic paper management server 53 on the network N to correspond to a user ID, a paper ID and a pad ID.

As has been described above with reference to FIG. 3, in the electronic circuit of electronic paper 11A (11B), the nonvolatile display unit 17 (17R, 17L), ID storage section 20, information storage unit 21, electromagnetic induction power supply unit 22, communication unit 23, input unit 24 (24R, 24L), overlap sensors 25 (25R, 25L) and calibration pointers 26a to 26d are formed around the control unit 19 composed of a low-tech CPU, such as a flexible IC-chip computer, and connected to the control unit 19.

As has been described above with reference to FIG. 4, in the electronic circuit of electronic pad 12B (12A), tablets 14R and 14L (14), ID storage section 29, information storage unit 30, input units 31R and 31L (31), contact-type display interface 32, external connection unit 33, electromagnetic induction power supply units 35R and 35L (35), communication units 37R and 37L (37) and power supply unit (battery), 38 are formed around the control unit 28 composed of a low-tech CPU, such as a flexible IC-chip computer, and connected to the control unit 28.

Electronic paper 11A (11B) is mounted on tablets 14R and 14L (14) and bound in electronic pad 12B (12A) by the binder unit 16 (13), as shown in FIGS. 1 and 2, causing the electromagnetic induction power supply units 35R and 35L (35) of electronic pad 12B (12A) to be connected electromagnetically to the electromagnetic induction power supply unit 22 of electronic paper 11A (11B) via the electromagnetic induction unit as shown in FIGS. 5 and 6. Moreover, the communication units 37R and 37L (37) of electronic paper 12B (12A) are connected electromagnetically to the communication unit 23 of electronic paper 11A (11B).

Then, the coordinates of the electromagnetic induction signals generated from the calibration pointers 26a to 26d of electronic paper 11A (11B) are detected by tablets 14R and 14L (14) of electronic pad 12B (12A), thereby detecting the mounting position of electronic paper 11A (11B) on tablets 14R and 14L (14).

The electronic pen 15 includes an ID storage section 15a which stores the pen ID, an IC chip control section 15b which reads the pen ID from the ID storage section 15a and generates and outputs a code signal, and a communication unit 15c having a coil which converts the code signal of the pen ID, which is generated and output from the control section 15b, into an electromagnetic induction signal and outputs the signal.

Program data used for the control unit 19 to control each circuit section of electronic paper 11A (11B) is stored in the information storage unit 21. The information storage unit 21 stores not only unique information on the specifications of electronic paper 11A (11B), but also display data for displaying, on the nonvolatile display unit 17 (17R, 17L), data corresponding to key operation input from the input unit 24 (24R, 24L), handwriting position detection input to electronic pad 12B (12A) from the electronic pen 15, and input of different content items, such as text and images from the externally connected information providing server 53W and the electronic paper management server 53.

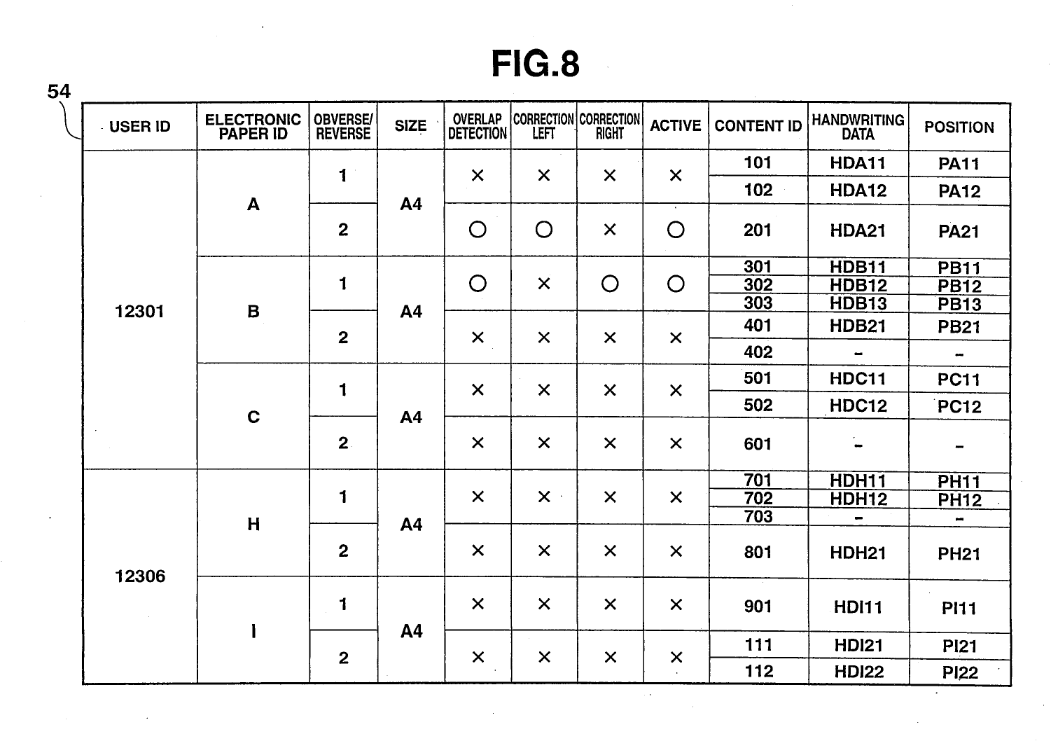

Program data (including the Web browser) for the control unit 28 to control each circuit section of electronic pad 12B (12A) is stored in the information storage unit 30. Moreover, the information storage unit 30 temporarily stores not only management information (FIG. 8) for managing each electronic paper 11A (11B) bound in, but also display data for transmitting to and displaying on the presently valid (active) electronic paper 11A (11B) data corresponding to key operation input from the input units 31R and 31L (31), handwriting position detection input to tablets 14R and 14L (14) from the electronic pen 15, or input of different content items, such as text and images from the externally connected information providing server 53W and the electronic paper management server 53. Like electronic paper 11A (11B), the display unit 45 is bound in the binder unit 16 (13) of electronic pad 12B (12A) as needed. The display unit is connected by the respective contact-type display interface 32 and 52. In the display unit 45, too, an LCD display unit 46 is able to display data corresponding to handwriting position detection input to electronic pad 12B (12A) from the electronic pen 15 or input of different content items, such as text and images from the externally connected information providing server 53W and electronic paper management server 53.

The information providing server 53W and electronic paper management server 53 on the network N can be connected to the external connection unit 33 of electronic pad 12A (12B) directly or via a communication terminal unit 61, such as a PC and a cellular phone, through wire communication or wireless communication.

FIG. 8 shows an electronic paper management table (pad) 54 stored and managed in the information storage unit 30 of electronic pad 12B (12A) in electronic paper recording apparatuses 10A and 10B of the first embodiment.

When electronic paper 11A (11B) is bound by the binder unit 16 (13) of electronic pad 12B (12A) and mounted on tablets 14R and 14L, the electronic paper management table (pad) 54 stores unique information (electronic paper ID, obverse and reverse side code, size) on each electronic paper 11A (11B) received in communication from each electronic paper 11A (11B), overlap detection information from the overlap sensor 25 (25R, 25L), correction information for the handwriting position recognized when the coordinates of the positions of the calibration pointers 26a to 26d of each electronic paper 11A (11B) are detected by tablets 14R and 14L (14), and active (valid) information determined by adding the overlap detection information, so as to correspond to the user ID input by a user from the input unit 24R (24L). The electronic paper management table (pad) 54 also stores display information (content ID of display data, and handwriting data and its position of display data) displayed on the obverse and reverse sides of each electronic paper 11A (11B).

Of the different items of information stored in the electronic paper management table (pad) 54, the overlap detection information, correction information for the handwriting position and active (valid) information are updated and stored in real time.

According to the electronic paper management table 54, presently valid (active) electronic paper 11A (11B) on the right and left faces of electronic pad 12B (12A) is recognized. Then, the process of inputting an operation signal and the processes of displaying and registering display data are carried out on the basis of the valid (active) electronic paper ID.

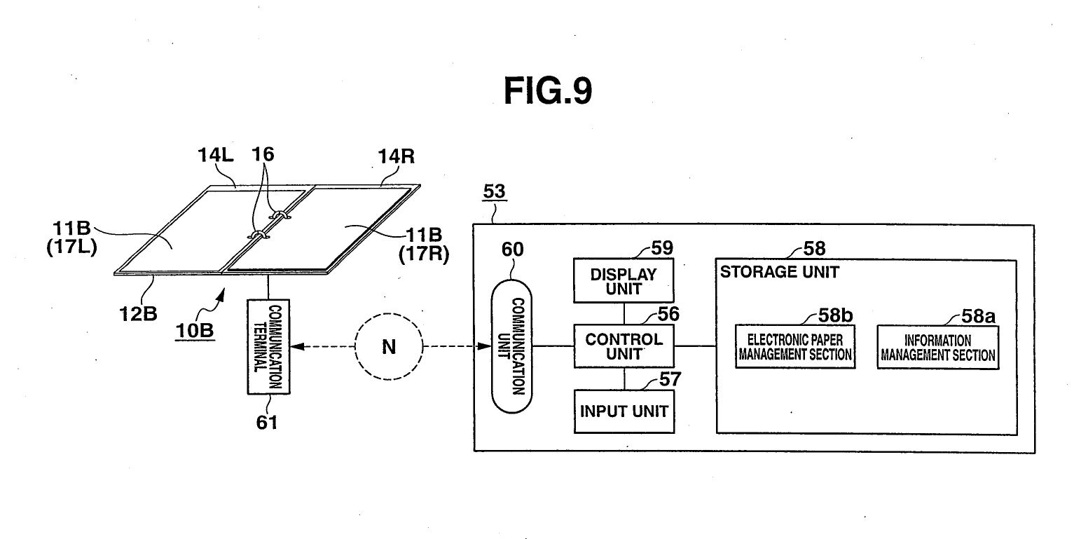

FIG. 9 is a block diagram showing a configuration of electronic paper recording apparatus 10B which is connected as a terminal to the electronic paper management server 53 on the network (Internet) N on the web access basis.

The electronic paper management server 53 includes a control unit 56 composed of a CPU that is a computer. An input unit 57, a storage unit 58 and a display unit 59 are formed around the control unit 56 and connected to the control unit 56. A communication unit 60 makes a communication connection with a terminal (electronic paper recording apparatus 10B) on the network (Internet) N directly or via the communication terminal unit 61 such as a PC and a cellular phone.

The storage unit 58 of the electronic paper management server 53 secures an information managing section 58a for storing and managing various items of control information such as electronic paper management programs and an electronic paper management section 58b for storing and managing information such as content items to be registered or delivered according to a request from each terminal (electronic paper recording apparatus 10B) so as to correspond to the user ID, pad ID and paper ID.

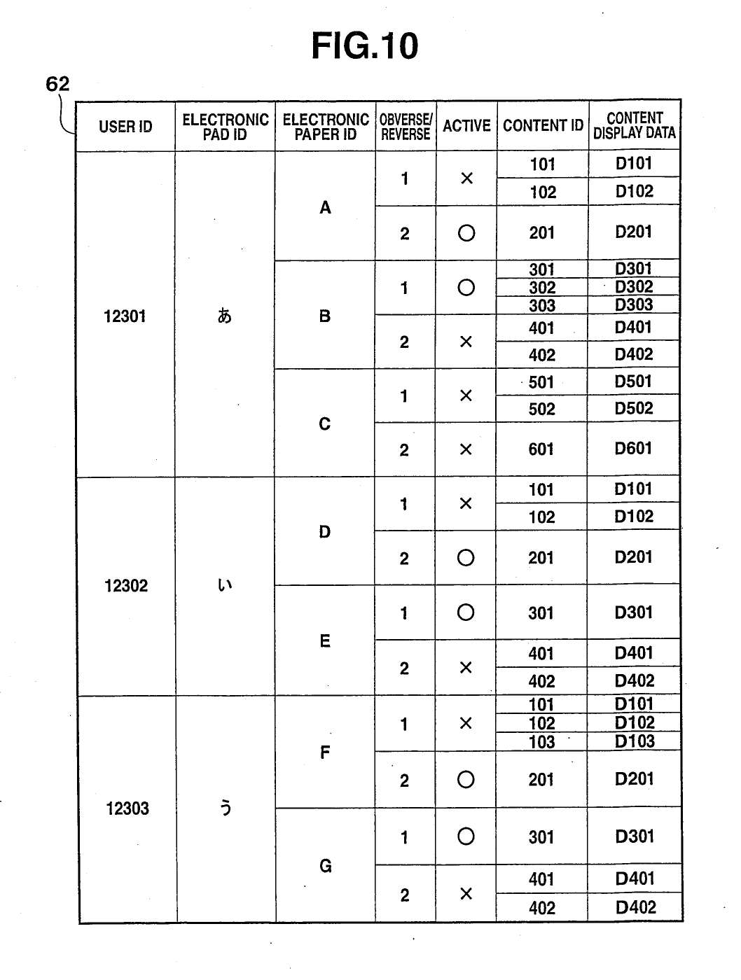

FIG. 10 shows an electronic paper management table (server) 62 stored and managed in the electronic paper management section 58b of the electronic paper management server 53.

Upon receiving the user ID, electronic pad ID, electronic paper ID and its obverse and reverse codes and active (valid) information, and display information (content ID and content display data) of the obverse and reverse sides from a logged-in terminal (electronic paper recording apparatus 10B), the electronic paper management table (server) 62 stores them to correspond to one another.

Of the different items of information stored in the electronic paper management table (server) 62, the active (valid) information of electronic paper 11A (11B) is updated and stored in real time and the display information (content ID and content display data) is updated and stored newly upon receipt of a request for registration.

An operation of electronic paper recording apparatuses laps 10A and 10B with the above-described configuration, which are incorporated as terminals of a cloud computing system (FIGS. 7-10), will be described.

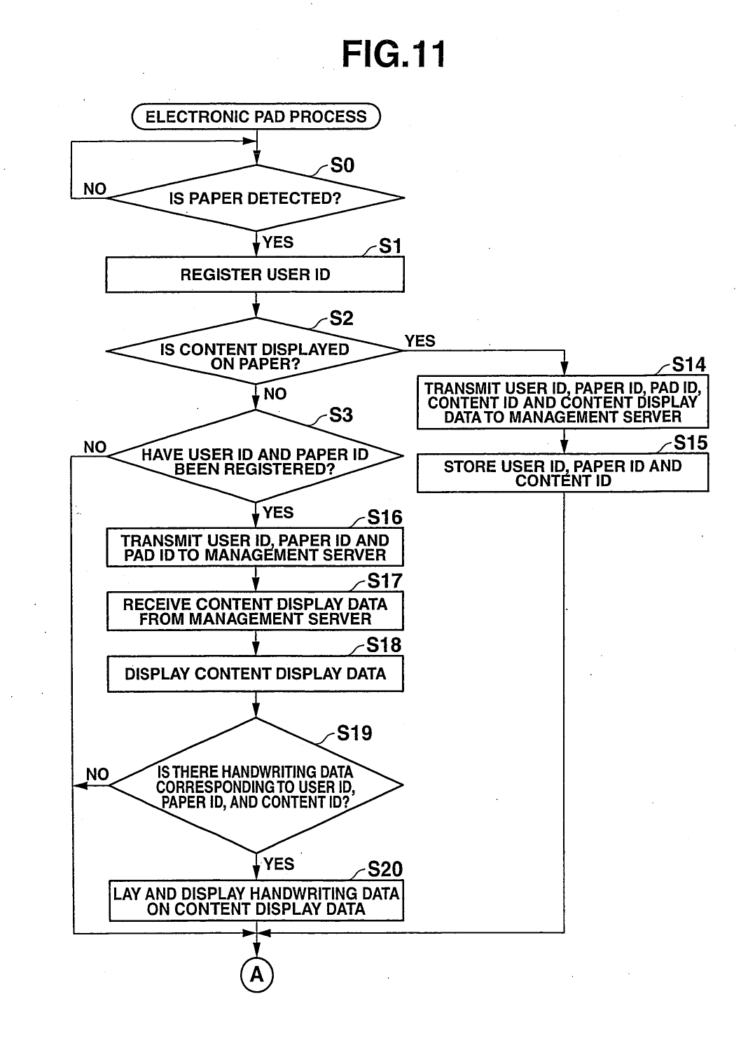

FIG. 11 is a flowchart showing a process (part 1) of electronic pads 12A and 12B of the first embodiment in the cloud computing system into which electronic paper recording apparatuses 10A and 10B are incorporated as terminals.

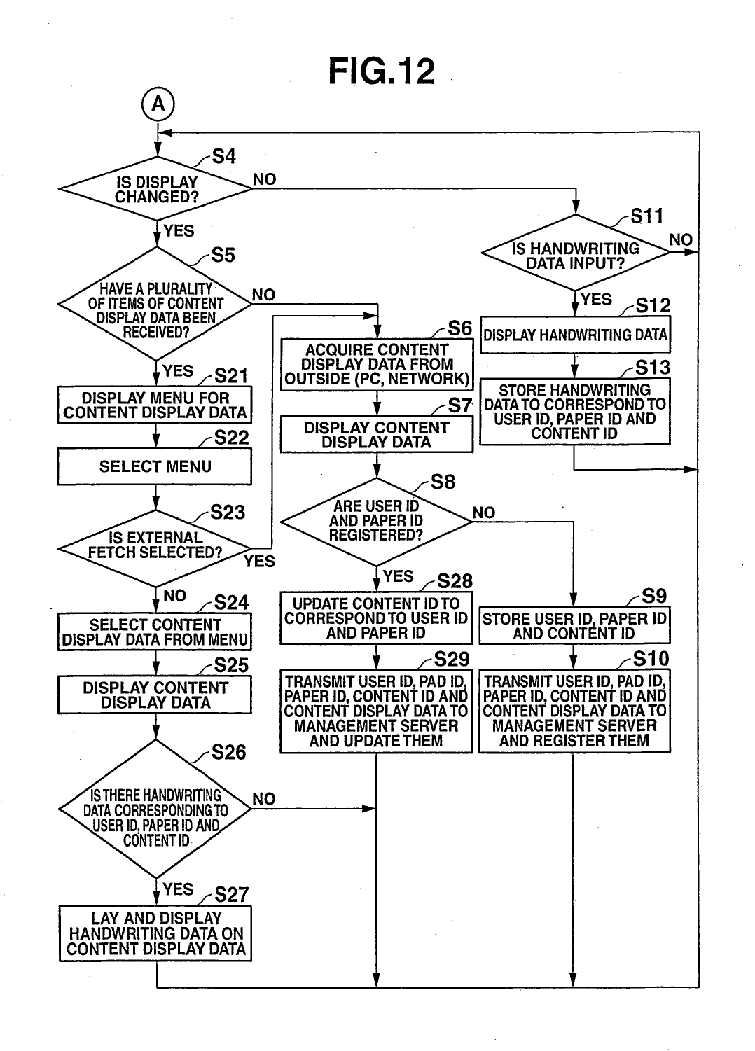

FIG. 12 is a flowchart showing a process (part 2) of electronic pads 12A and 12B of the first embodiment in the cloud computing system into which electronic paper recording apparatuses 10A and 10B are incorporated as terminals.

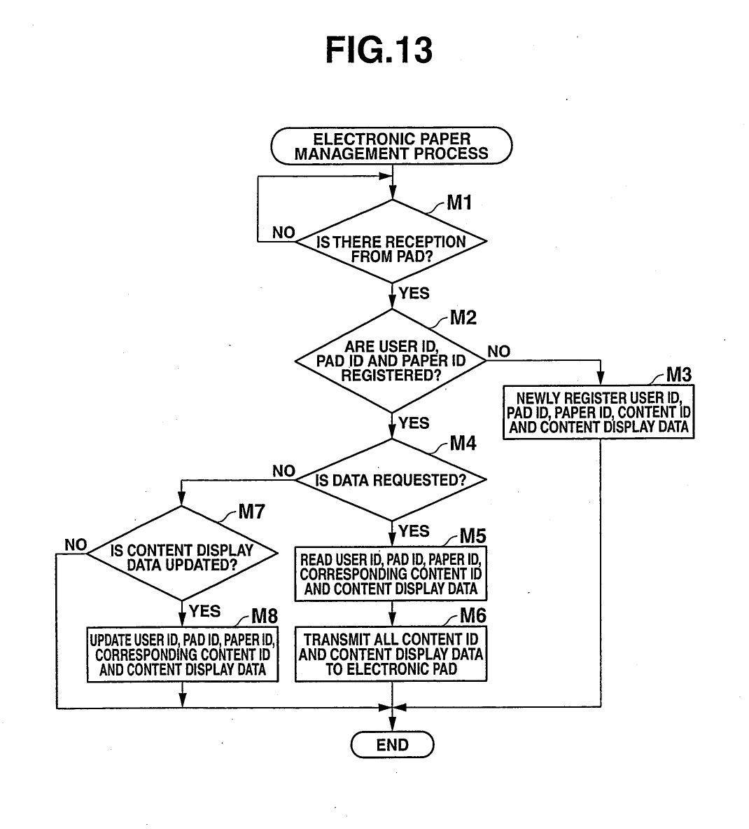

FIG. 13 is a flowchart showing a process of the electronic paper management server 53 in the cloud computing system into which electronic paper recording apparatuses 10A and 10B are incorporated as terminals.

If the control unit 28 determines that electronic paper (double-sided type) 11B is mounted on electronic pad (double-sided type) 12B of electronic paper recording apparatus (double-sided type) 10B in accordance with the detection of connection at the electromagnetic induction power supply units 35R and 35L and the communication units 37R and 37L in the binder unit 16 (step S0 [Yes]), a message for requesting a user to register a user ID is displayed in a given position of the nonvolatile display unit 17 of the mounted electronic paper 11B. When the user ID is input according to a user operation of the input unit 24, it is registered in the electronic paper management table (pad) 54 (FIG. 8) of the information storage unit 30 (step S1).

It is determined whether or not the nonvolatile display unit 17 displays any content according to whether or not the information storage unit 21 of electronic paper 11B stores display data of some content (step S2).

If it is determined that the nonvolatile display unit 17 of electronic paper 11B displays no content (step S2 [No]), it is determined whether or not the electronic paper ID read from the ID storage section 20 of electronic paper 11B has already been registered to correspond to the user ID registered in the electronic paper management table (pad) 54 (step S3).

If it is determined that the electronic paper ID of electronic paper 11B has not yet been registered to correspond to the user ID registered in the electronic paper management table (pad) 54 (step S3 [No]) and then the change of display is instructed according to user operation from the input unit 24 of electronic paper 11B (step S4 [Yes]), it is determined whether or not a plurality of items of content display data to be displayed on electronic paper 11B have already been received from the electronic paper management server 53 on the network N via the external connection unit 33 (step S5).

If it is determined that the plurality of items of content display data have not yet been received (step S5 [No]), arbitrary content display data is acquired directly from the communication terminal unit 61 such as a PC via the external connection unit 33 or selectively from the information providing server 53W on the network N via the communication terminal unit 61 (step S6). Thus, the acquired content display data is displayed on the nonvolatile display unit 17 of electronic paper 11B (step S7).

It is thus determined whether or not the electronic paper ID read from the ID storage section 20 of electronic paper 11B is registered to correspond to the user ID registered in the electronic paper management table (pad) 54 (FIG. 8) of the information storage unit 30 (step S8).

If it is determined that the electronic paper ID of electronic paper 11B is not registered to correspond to the user ID of the electronic paper management table (pad) 54 (step S8 [No]), the electronic paper ID read from the ID storage section 20 of electronic paper 11B and the content ID of content display data displayed in the nonvolatile display unit 17 of electronic paper 11B are stored to correspond to the user ID of the electronic paper management table (pad) 54 (step S9).

More specifically, as shown in FIG. 8, for example, content ID “201” is stored to correspond to user ID “12301” and active (valid) reverse side “2” of electronic paper ID “A.”

Furthermore, the user ID stored in the electronic paper management table (pad) 54, the electronic pad ID read from the ID storage section 29 of electronic pad 12B, the electronic paper ID read from the ID storage section 20 of electronic paper 11B, and the content display data displayed on electronic paper 11B and its display data are transmitted to the electronic paper management server 53 on the network N via the external connection unit 33, and then registered in the electronic paper management table (server) 62 (FIG. 10) (step S10).

If the electronic paper management server 53 receives the user ID transmitted from electronic pad 12B, electronic pad ID, electronic paper ID, and content ID displayed on electronic paper 11B and its display data (step M1 [Yes]), it is determined whether or not the management data corresponding to the received user ID, electronic pad ID and electronic paper ID has already been registered in the electronic paper management table (server) 62 of the electronic paper management section 58b (step M2).

If it is determined that the management data corresponding to the received user ID, electronic pad ID and electronic paper ID is not registered in the electronic paper management table (server) 62 (step M2 [No]), the received user ID, electronic pad ID and electronic paper ID, and the content ID displayed on electronic paper 11B and its display data are newly registered to correspond to one another (step M3).

More specifically, as shown in FIG. 10, for example, content ID “201” and content display data “D201” are registered to correspond to user ID “12301,” electronic pad ID “ [symbol] ” and active (valid) reverse side “2” of electronic paper ID “A.”

If handwriting input with the electronic pen 15 is detected by tablet 14L while display data “D201” of content ID “201” is displayed on the active (valid) reverse side “2” of electronic paper “A” 11B of electronic pad “ [symbol] ” 12B (step S11 [Yes]), a locus associated with the handwriting input is laid on the content display data “D201” that is being displayed on the reverse side “2” of electronic paper “A” 11B (step S12).

In the electronic paper management table (pad) 54 of electronic pad “ [symbol] ” 12B, the handwriting data by the handwriting input and its positional information are stored as handwritten data “HDA21” that corresponds to the user ID “12301,” active (valid) reverse side “2” of electronic paper ID “A” and content ID “201” and its positional information “PA21” as shown in FIG. 8, for example (step S13).

When electronic paper 11B is mounted on and the user ID is registered in electronic pad 12B (steps S0 and S1), if it is determined that content has already been displayed on the nonvolatile display unit 17 of electronic paper 11B (step S2 [Yes]), the registered user ID, the electronic paper ID read from the ID storage section 20 of mounted electronic paper 11B, the electronic pad ID read from the ID storage section 29 of electronic pad 12B, and the display data read from the information storage unit 21 of electronic paper 11B and its content ID are transmitted to the electronic paper management server 53 on the network N to correspond to one another (step S14).

The electronic paper management table (pad) 54 stores the electronic paper ID of mounted electronic paper 11B and the content ID of the display data that is being displayed, so as to correspond to the registered user ID (step S15).

If the electronic paper management server 53 determines that the received user ID, the electronic pad ID or the management data corresponding to the electronic paper ID is not registered in the electronic paper management table 62 of the electronic paper management section 58b (steps M1 and M2 [No]), the received user ID, electronic pad ID, electronic paper ID, and content ID that is being displayed on electronic paper 11B and its display data are newly registered to correspond to one another (step M3).

When it is determined that the management data corresponding to the received user ID, electronic pad ID and electronic paper ID are registered in the electronic paper management table 62 (FIG. 10) (step M2 [Yes]), if the content ID registered to correspond to the combination of the user ID, electronic pad ID and electronic paper ID and the received content ID differ from each other, it is determined that the content display data is updated (step M7 [Yes]), and the registered content ID and its display data are updated to the received content ID and its display data and registered so as to correspond to the combination of the user ID, electronic pad ID and electronic paper ID (step M8).

More specifically, as shown in FIG. 10, for example, content IDs “301,” “302” and “303” are registered to correspond to user ID “12301,” electronic pad ID “ [symbol] ” and active (valid) obverse side “1” of electronic paper ID “B.” If the currently received content ID is a different ID “304,” the earliest registered content ID “301” and its display data “D301” are updated to the currently received content ID “304” and its display data “D304” and then registered.

If handwriting input with the electronic pen 15 is detected by tablet 14R while the display data “D303” of content ID “303” is displayed on the obverse side “1” of electronic paper “B” 11B of electronic pad “ [symbol] ” 12B (step S11 [Yes]), a locus associated with the handwriting input is laid on the content display data “D303” that is being displayed on the obverse side “1” of electronic paper “B” 11B (step S12).

In the electronic paper management table (pad) 54 of electronic pad “ [symbol] ” 12B, the handwriting data associated with the handwriting input and its positional information are stored as handwritten data “HDB13” that corresponds to the user ID “12301,” active (valid) obverse side “1” of electronic paper ID “B” and content ID “303” and its positional information “PB13” as shown in FIG. 8, for example (step S13).

When electronic paper 11B is mounted on and the user ID is registered in electronic pad 12B (steps S0 and S1), if it is determined that no content is displayed on the nonvolatile display unit 17 of electronic paper 11B (step S2 [No]) and it is determined that the electronic paper ID read from the ID storage section 20 of electronic paper 11B has already been registered to correspond to the registered user ID of the electronic paper management table (pad) 54 (step S3 [Yes]), the user ID, the electronic paper ID, and the electronic pad ID read from the ID storage section 29 are transmitted to the electronic paper management server 53 on the network N via the external connection unit 33 (step S16).

More specifically, the user ID “12301,” electronic paper ID “B” and electronic pad ID “ [symbol] ” of electronic pad 12B, which have been registered in the electronic paper management table (pad) 54, are transmitted to the electronic paper management server 53, as shown in FIG. 8, for example.

When the electronic paper management server 53 receives the user ID “12301,” electronic paper ID “B” and electronic pad ID “ [symbol] ” from electronic pad 12B (step M1 [Yes]), if it determines that they have been registered in an electronic paper management table (server) 62 (FIG. 10) (step M2 [Yes]), it determines that not a request for registration of display data but a request for transmission of display data is made because the received data does not include content display data (step M4 [Yes]).

All the content IDs “301,” “302” and “303” and their content display data “D301,” “D302” and “D303” which are registered to correspond to the user ID “12301,” electronic pad ID “ [symbol] ” and active (Valid) obverse side “1” of electronic paper ID “B” which are received from electronic pad 12B in the electronic paper management table (server) 62, are read (step M5) and transmitted to electronic pad “ [symbol] ” 12B (step M6).

If electronic pad “ [symbol] ” 12B receives the content IDs “301,” “302” and “303” and their content display data “D301,” “D302” and “D303” from the electronic paper management table 53 (step S17), the latest content display data “D303” is written to an information storage unit 21 of electronic paper “B” 11B and displayed on the nonvolatile display unit 17R of the active (valid) obverse side “1” (step S18). In the meantime, if the data received from the electronic paper management server 53 is a content ID and its content display data, the display data is displayed on the nonvolatile display unit 17 of electronic paper 11B.

It is determined that the handwriting data “HDB13,” which corresponds to the user ID “12301” and electronic paper ID “B” determined to have been registered in the electronic paper management table (pad) 54 in accordance with the process of step S3 and also corresponds to the ID “303” of the content display data “D303” displayed on the nonvolatile display unit 17R, are registered (step S19 [Yes]), the handwriting data “HDB13” is laid and displayed on the content display data “D303” that is being displayed on the nonvolatile display unit 17R of the obverse side “1” of electronic paper “B” 11B in accordance with the positional information “PB13” thereof (step S20).

After that, if the change of display is instructed according to user operation from the input unit 24 of electronic paper 113 (step S4 [Yes]), it is determined whether or not a plurality of items of content display data to be displayed on electronic paper 11B have already been received from the electronic paper management server 53 on the network N via the external connection unit 33 (step S5).

In step S17, it is determined that three content IDs “301,” “302” and “303” and their content display data “D301,” “D302” and “D303” are received from the electronic paper management table 53 (step S5 [Yes]), a display selection menu in which a selection item for instructing external fetch is added to the selection items of the content display data “D301,” “D302” and “D303” is window-displayed on the nonvolatile display unit 17R of the obverse side “1” of electronic paper “B” 11B (step S21).

If the window-displayed display selection menu is selected according to a user operation (step S22), it is first determined whether the selection item for instructing external fetch is selected or not (step S23).

When it is determined that the selection item for instructing external fetch is not selected (step S23 [No]), if one of the received content display data “D301,” “D302” and “D303,” for example, content display data “D301” is selected (step S24), the selected data “D301” is written to the information storage unit 21 of electronic paper “B” 11B and displayed on the nonvolatile display unit 17R of the active (valid) obverse side “1” on which the content display data “D303” is displayed (step S25).

If it is determined that handwriting data “HDB11” is registered in the electronic paper management table (pad) 54 (FIG. 8) so as to correspond to the registered user ID “12301,” the electronic paper ID “B” of electronic paper 11B and the content ID “301” of the selected and displayed content display data “D301” (step S26 [Yes]), the handwriting data “HDB11” is laid and displayed on the content display data “D301” that is being displayed on the nonvolatile display unit 17R of the obverse side “1” of electronic paper “B” 11B in accordance with the positional information “PB11” of the handwriting data (step S27).

If, in step S23, it is determined that the selection item for instructing external fetch is selected from the window-displayed display selection menu (step S23 [Yes]), arbitrary content display data is selectively acquired directly from the communication terminal unit 61 such as a PC through the external connection unit 33 or from the information providing server 53W on the network N through the communication terminal unit 61 (step S6) and displayed on the nonvolatile display unit 17R of the obverse side “1” of electronic paper “B” 11B (step S7).

If it is determined that the electronic paper ID “B” read from the ID storage unit 20 of electronic paper 11B is registered in the electronic paper management table (pad) 54 (FIG. 8) to correspond to the user ID “12301” (step S8 [Yes]), the earliest registered content ID “301” is updated to the content ID (for example, “304”) of the content display data newly displayed in steps S6 and S7 and stored to correspond to the user ID “12301” and the active (valid) obverse side “1” of the electronic paper ID “B” which have been registered in the electronic paper management table (pad) 54 (step S28). In this case, the handwriting data “HDB11” corresponding to the updated content ID “304” and its positional information “PB11” are erased.

The user ID “12301,” electronic pad ID “ [symbol] ” read from the storage section 29 of electronic pad 12B, the electronic paper ID “B” read from the ID storage section 20 of electronic paper 11B, and content ID “304” that is being displayed on electronic paper 11B and its display data (for example, “D304”) are transmitted to the electronic paper management server 53 on the network N via the external connection unit 33 and registered in the electronic paper management table (server) 62 (step S10).

If the electronic paper management server 53 determines that the management data corresponding to the user ID “12301,” electronic pad ID “ [symbol] ” and electronic paper ID “B” which are received from electronic pad 12B is registered in the electronic paper management table (server) 62 (FIG. 10) (step M1 and step M2 [Yes]), it is determined that the content display data is updated on the ground that the content IDs “301,” “302” and “303” registered to correspond to the combination of the user ID “12301,” electronic pad ID “ [symbol] ” and active (valid) obverse side “1” of the electronic paper ID “B” and the received content ID “304” differ from each other (step M7 [Yes]).

In the electronic paper management table (server) 62, the earliest registered content ID “301” and its display data “D301” are updated to the received content

ID “304” and its display data “D304” and stored to correspond to the combination of the user ID “12301,” electronic pad ID “ [symbol] ” and active (valid) obverse side “1” of the electronic paper ID “B” (step M8).

According to electronic paper recording apparatuses 10A and 10B having the above configuration, if, in electronic pad 12A (12B), while given content display data is displayed on the nonvolatile display unit 17 of electronic paper 11A (11B) mounted on the tablet 14, input of handwriting data (or input of character data from the input unit 24) corresponding to a user operation is detected and the handwriting data (or character data) is laid and displayed as added data on the content display data that is being displayed, the added data and its positional information are registered in the electronic paper management table (pad) 54 of the information storage unit 30 so as to correspond to the content ID of the content display data displayed on electronic paper 11A (11B). Then, when the placement of electronic paper 11A (11B) is newly detected, if the added data that corresponds to the content ID of the content display data displayed on electronic paper 11A (11B) is registered in the electronic paper management table (pad) 54, the added data and its positional information are read and laid and redisplayed on the displayed content display data.

If, therefore, a user has only to mount electronic paper 11A (11B) on electronic pad 12A (12B) to redisplay the content display data that has been displayed before, he or she can use electronic pad 12A (12B) to promptly read and redisplay the added data which has been laid and displayed on the content display data before. Accordingly, the user can reconfirm the content added onto the content display data only by a specific electronic pad 12A (12B) without causing any data capacity problem or security problem on the external server.

According to electronic paper recording apparatuses 10A and 10B having the above configuration, if in electronic pad 12A (12B), input of handwriting data (or input of character data from the input unit 24) corresponding to a user operation on electronic paper 11A (11B) mounted on the tablet 14 is detected and the handwriting data (or character data) is laid and displayed as added data on the content display data that is being displayed on the nonvolatile display unit 17, the added data and its positional information are registered in the electronic paper management table (pad) 54 of the information storage unit 30 so as to correspond to the paper ID of electronic paper 11A (11B). Then, when the mounting of electronic paper 11A (11B) is newly detected, if the added data that corresponds to the paper ID of electronic paper 11A (11B) is registered in the electronic paper management table (pad) 54, the added data and its positional information are read and laid and redisplayed on the content display data that is being displayed on electronic paper 11A (11B).

If, therefore, a user has only to mount electronic paper 11A (11B) on electronic pad 12A (12B), he or she can use electronic pad 12A (12B) to promptly read and redisplay the added data, which has been laid and displayed before on the content display data that is displayed on electronic paper 11A (11B). Accordingly, the user can reconfirm the content added onto the display data of electronic paper 11A (11B) only by the combination of a specific electronic pad 12A (12B) and electronic paper 11A (11B), without causing any data capacity problem or security problem on the external server.

According to electronic paper recording apparatuses 10A and 10B having the above configuration, the content display data displayed on electronic paper 11A (11B) mounted on electronic pad 12A (12B) is registered in the electronic paper management table (server) 62 of the externally connected electronic paper management server 53 to correspond to the pad ID and paper ID. When the mounting of electronic paper 11A (11B) is newly detected, if the pad ID of electronic pad 12A (12B) and the paper ID of electronic paper 11A (11B) are transmitted to the paper management server 53 and the content display data corresponding to the pad ID and paper ID is registered in the electronic paper management table (server) 62, the content display data is received and redisplayed on electronic paper 11A (11B). Then, the added data and its positional information, which are registered in the electronic paper management table (pad) 54 to correspond to the content ID of the redisplayed content display data or the paper ID of the mounted electronic paper 11A (11B), are read and laid and redisplayed on the content display data that is being displayed on electronic paper 11A (11B).

If, therefore, a user has only to mount electronic paper 11A (11B) on electronic pad 12A (12B), he or she can promptly redisplay the content display data stored and managed to correspond to the pad ID and paper ID and read and redisplay the added data, which has been laid and displayed before on the content display data. Accordingly, the user can promptly reconfirm the content display data and its added data displayed on electronic paper 11A (11B) only by the combination of a specific electronic pad 12A (12B) and electronic paper 11A (11B).

According to electronic paper recording apparatuses 10A and 10B having the above configuration, in electronic pad 12A (12B), in electronic pad 12A (12B), the nonvolatile display unit 17 of electronic paper 11A (11B) mounted on the table 14 displays arbitrary content display data selected from among a plurality of items of content display data, and the added data on the content display data and its positional information are registered in the electronic paper management table (pad) 54 so as to correspond to the paper ID of electronic paper 11A (11B and the content ID of the content display data that is being displayed). Then, when the mounting of electronic paper 11A (11B) is newly detected, if the added data that corresponds to the paper ID of electronic paper 11A (11B) and the content ID of the selected and displayed content display data is registered in the electronic paper management table (pad) 54, the added data and its positional information are read and laid and redisplayed on the selected and displayed content display data.

If, therefore, a user has only to mount electronic paper 11A (11B) on electronic pad 12A (12B) to selectively redisplay the content display data that has been displayed before, he or she can use electronic pad 12A (12B) and electronic paper 11A (11B) to promptly read and redisplay the added data which has been laid and displayed on the content display data before. Accordingly, the user can reconfirm the content display data and its added data displayed on electronic paper 11A (11B) only by the combination of a specific electronic pad 12A (12B) and electronic paper 11A (11B) without causing any data capacity problem or security problem on the external server.

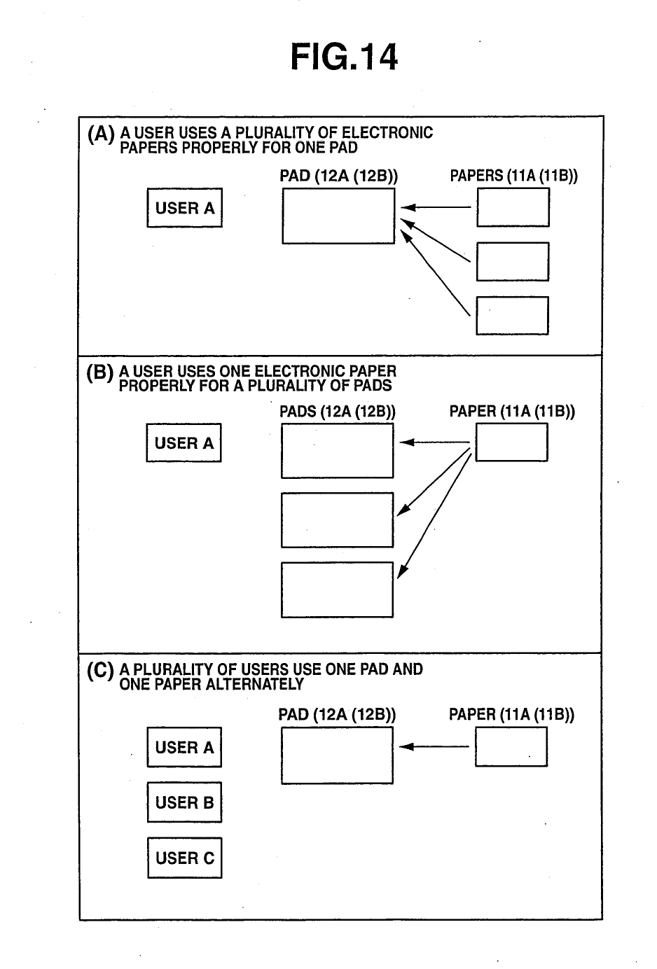

FIG. 14 is an illustration of a specific usage pattern of electronic paper recording apparatuses 10A and 10B managed by the electronic paper management server 53.

As described above, in electronic paper recording apparatuses 10A and 10B, for each sheet of electronic paper 11A (11B) mounted on electronic pad 12A (12B), the content display data displayed on electronic paper 11A (11B) is registered and managed to correspond to the pad ID and paper ID. Therefore, not only when a user A uses a plurality of electronic papers 11A (11B) properly in one electronic pad 12A (12B) as shown in FIG. 14(A) but also when user A uses electronic pads 12A (12B) in different places properly for one electronic paper 11A (11B) as shown in FIG. 14(B), user A can redisplay the last-displayed content display data promptly on electronic paper 11A (11B) simply by placing electronic paper 11A (11B) on electronic pad 12A (12B).

Furthermore, the content display data registered to correspond to the electronic pad ID and electronic paper ID is also registered and managed to correspond to the user ID. As shown in FIG. 14(C), therefore, even though a plurality of users A and B use one electronic pad 12A (12B) and electronic paper 11A (11B) alternately, each of users A and B can redisplay the last-displayed content display data promptly on electronic paper 11A (11B) simply by inputting the user ID.

In electronic paper recording apparatuses 10A and 10B according to the first embodiment, the electronic paper management table (pad) 54 of electronic pad 12A (12B) is configured to store the paper ID of the mounted electronic paper 11A (11B), the content ID of the displayed content display data, and the added and displayed handwriting data and its positional information so as to correspond to one another and redisplay the content display data corresponding to electronic pad 12A (12B) used by a user and its handwriting data.

As will be described with respect to electronic paper recording apparatuses 10A and 10B according to the following second embodiment, electronic paper 11A (12B) is configured to store the pad ID of electronic pad 12A (12B) used with electronic paper 11A (12B) mounted thereon, the content ID of the displayed content display data, and the added and displayed handwriting data and its positional information so as to correspond to one another and to display the content display data corresponding to electronic pad 12A (12E) used by a user and its handwriting.

### Second Embodiment

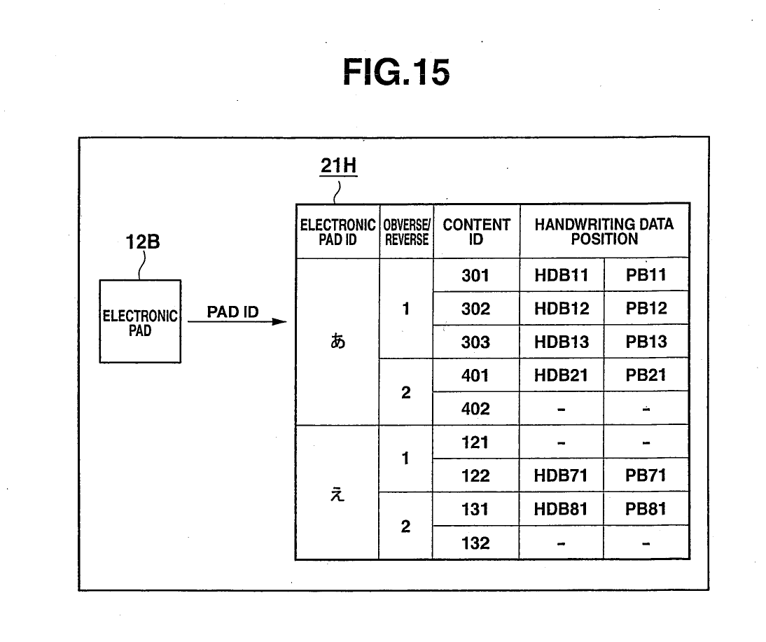

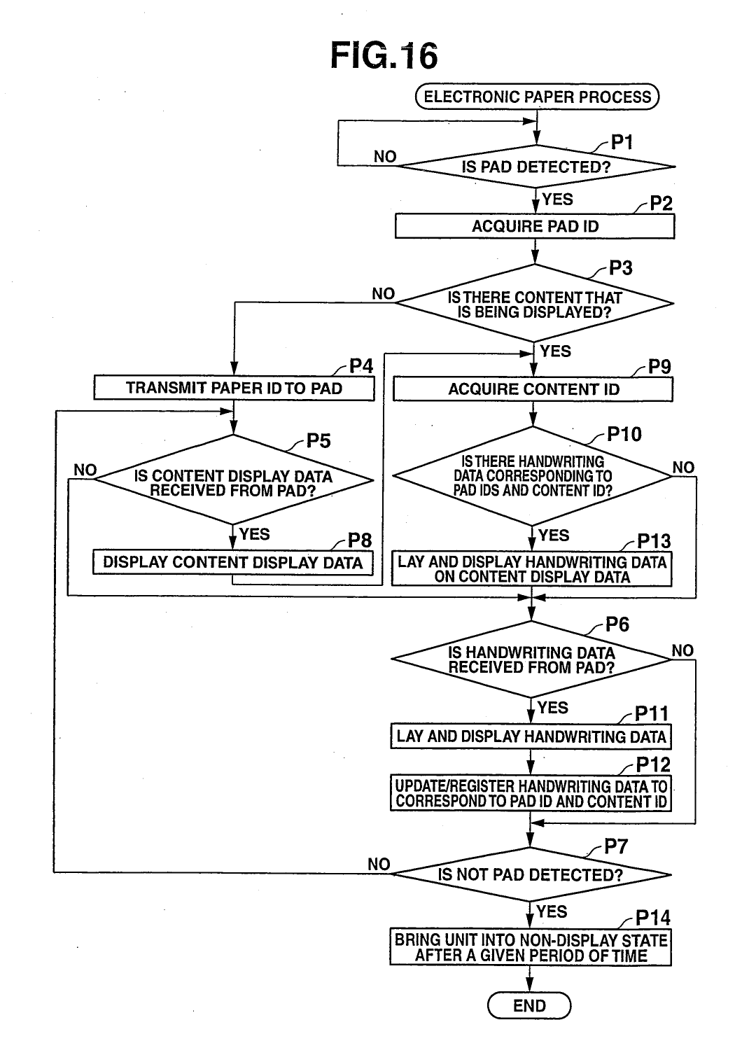

In electronic paper recording apparatuses 10A and 10B according to the second embodiment, a handwriting data storage section 21H (FIG. 15) that is secured as a storage area in an information storage unit 21 of electronic paper 11A (11B) stores handwriting data corresponding to a pad ID and a content ID and its positional information. Electronic paper 11A (11B) performs processes for storing, determining and displaying the handwriting data and its positional information (FIG. 16).

Thus, the electronic paper management table (pad) 54 (FIG. 8) of electronic pad 12A (12B) stores neither the handwriting data nor its positional information. Accordingly, electronic pad 12A (12B) performs neither the process of storing handwriting data and its positional information in the electronic paper management table (pad) 54 (step S13) nor the process of determining the presence or absence of handwriting data and reading and displaying it (steps S19, S20/S26, S27) (FIGS. 11 and 12).

FIG. 15 shows the handwriting data storage unit 21H stored and managed in electronic paper 11B of electronic paper recording apparatus (double-sided type) 10B according to the second embodiment.

When the electronic paper is mounted on electronic pad 12B, the handwriting data storage unit 21H stores the content ID of displayed content display data and handwriting data input by handwriting on the content display data and its positional information so as to correspond to the pad ID of electronic pad 12B.

FIG. 16 is a flowchart showing a process of electronic paper 11B of electronic paper recording apparatus (double-sided type) 10B according to the second embodiment.

In accordance with the control program stored in the information storage unit 21, the process of electronic paper 11B is performed as follows.

If electronic paper 11B detects that electronic paper 11B is mounted on a tablet 14 of electronic pad 12B upon receiving power from electronic pad 12B through an electromagnetic induction power supply unit 22 (step P1 [Yes]), the pad ID read from an ID storage section 29 of electronic pad 12B is acquired (step P2).

It is determined whether content is being displayed or not according to whether the information storage unit 21 stores content display data to be displayed on a nonvolatile display unit 17 (step P3).

When it is determined that no content is being displayed (step P3 [No]), the paper ID read from an ID storage section 20 is transmitted to electronic pad 12B on which the electronic paper is mounted (step P4).

Then, it is determined whether content display data is received from electronic pad 12B (step P5), it is determined whether handwriting data is received (step P6), and it is determined whether it is not detected that the electronic paper is mounted on electronic pad 12B (step P7).

If it is determined that a communication unit 23 receives content display data from electronic pad 12B (step P5 [Yes]) in accordance with the process of acquiring content display data from an information providing server 53W and displaying it (steps S6 and S7) and the process of receiving content display data from an electronic paper management server 53 and displaying it in electronic pad 12B (steps S17, S18/S24, S25), the received content display data is stored in the information storage unit 21 and displayed on the nonvolatile display unit 17 (step P8).

Then, the content ID of the displayed content display data is acquired (step P9), and it is determined whether the handwriting data storage section 21H (FIG. 15) stores handwriting data corresponding to the pad ID and content ID (step P10) or it is determined whether handwriting data and its positional information are received from electronic pad 12B (step P6).

Even though it is determined in step P3 that the nonvolatile display unit 17 of electronic paper 11B includes the displayed content display data (step P3 [Yes]), the content ID of the displayed content display data is acquired (step P9), and it is determined whether the handwriting data storage section 21H (FIG. 15) stores handwriting data corresponding to the pad ID and content ID (step P10) or it is determined whether handwriting data and its positional information are received from electronic pad 12B (step P6).

If it is determined that handwriting data and its positional information are received from electronic pad 12B (step P6 [Yes] in accordance with a process of displaying handwriting data in electronic pad 12B according to handwriting input on the content display data displayed on electronic paper 11B (steps S11 and S12), the received handwriting data is laid and displayed on the content display data that is being displayed (step P11).

Thus, the handwriting data and its positional information are stored and registered in the handwriting data storage section 21H (FIG. 15) to correspond to the pad ID and content ID (step P12).

If the handwriting data storage section 21H has already stored handwriting data to correspond to the pad ID and content ID, it is updated to the currently received handwriting data and its positional information and stored.

If it is determined in step P10 that the handwriting data storage section 21H (FIG. 15) stores handwriting data corresponding to the pad ID of electronic pad 12B on which the electronic paper is mounted and the content ID of the content display data that is being displayed (step P10 [Yes]), the handwriting data and its positional information are read and laid and displayed on the content display data that is being displayed on the nonvolatile display unit 17 (step P13).

After that, it is determined that electronic pad 12B is not detected because electronic paper 11B is detached from electronic pad 12B (step P7 [Yes]), the content display data and handwriting data displayed on the nonvolatile display unit 17 are erased after a lapse of given time period and the unit 17 is brought into a non-display state (step P14).

Therefore, according to electronic paper recording apparatuses 10A and 10B of the second embodiment with the above configuration, when handwriting data is input to and displayed on electronic paper 11A (11B) mounted on the tablet 14 of electronic pad 12A (12B), the input handwriting data and its positional information are stored in the handwriting data storage section 21H to correspond to the pad ID of electronic pad 12A (12B).

When electronic paper 11A (11B) is newly mounted on electronic pad 12A (12B), if the handwriting data corresponding to the pad ID acquired from electronic pad 12A (12B) is stored in the handwriting data storage section 21H, the handwriting data and its positional information are read, and the handwriting data is added to and displayed in a position corresponding to the positional information of the nonvolatile display unit 17 of electronic paper 11A (11B).

For this reason, a user can promptly read and redisplay the handwriting data, which was input by handwriting and displayed before, using electronic pad 12A (12B) simply by placing electronic paper 11A (11B) on electronic pad 12A (12B). Accordingly, the user can reconfirm the content added onto the display data on the nonvolatile display unit 17 only by a specific electronic pad 12A (12B), without causing any data capacity problem or security problem on the external server.

According to electronic paper recording apparatuses 10A and 10B of the second embodiment with the above configuration, if, in electronic paper 11A (11B) mounted on the tablet 14 of electronic pad 12A (12B), handwriting data is input and displayed on the content display data, which is read from the electronic paper management server 53 and received by and displayed on electronic paper 11A (11B), so as to correspond to the combination of the pad ID and the content display data or paper ID displayed on the nonvolatile display unit 17, the input handwriting data and its positional information are stored in the handwriting data storage section 21H to correspond to the pad ID of electronic pad 12A (12B) and the content ID of the content display data.

When electronic paper 11A (11B) is newly mounted on electronic pad 12A (12B) and content display data is displayed thereon, if the handwriting data corresponding to the pad ID and content ID is stored in the handwriting data storage section 21H, the handwriting data and its positional information are read, and the handwriting data is added to and displayed in a position corresponding to the positional information on the content display data that is being displayed.

Thus, a user can promptly read and redisplay the added data, which was input and laid and displayed before on the content display data displayed on electronic paper 11A (11B), using electronic pad 12A (12B) simply by placing electronic paper 11A (11B) on electronic pad 12A (12B). Accordingly, the user can reconfirm the content added onto the content display data of electronic paper 11A (11B) only by the combination of a specific electronic pad 12A (12B) and electronic paper 11A (11B), without causing any data capacity problem or security problem on the external server.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic pad apparatus on which electronic paper is mounted detachably, comprising:
a paper detection unit for detecting that the electronic paper is mounted;
a display data registration unit for transmitting a pad ID of the electronic pad apparatus, a paper ID of the electronic paper and content display data to an externally-connected server unit and registering the pad ID, the paper ID and the content display data to correspond to one another, the content display data being displayed on the electronic paper detected by the paper detection unit;
a data registration determination unit for determining whether the content display data corresponding to the pad ID and the paper ID is registered in the server unit when the paper detection unit detects that electronic paper is newly mounted;
a registered data reception unit for, when the data registration determination unit determines that the content display data corresponding to the pad ID and the paper ID is registered in the server unit, receiving the content display data from the server unit; and
a registered data display control unit for displaying the content display data received by the registered data reception unit on the newly mounted electronic paper.

2. The electronic pad apparatus according to claim 1, further comprising:
a paper ID storage unit for storing the paper ID of the electronic paper as a result of the display data registration unit transmitting the pad ID of the electronic pad apparatus, the paper ID of the electronic paper and the content display data to the externally-connected server unit and registering the pad ID, the paper ID and the content display data to correspond to one another,
wherein when the paper detection unit detects that electronic paper is newly mounted, the data registration determination unit determines whether the paper ID storage unit stores a paper ID of the electronic paper and determines the content display data corresponding to the pad ID of the electronic pad apparatus and the paper ID of the electronic paper is registered in the server unit,
the display data registration unit transmits the pad ID of the electronic pad apparatus, the paper ID of the electronic paper and the content display data that is being displayed on the electronic paper to the externally-connected server unit and registers the pad ID, the paper ID and the content display data to correspond to one another when the data registration determination unit determines that the paper ID storage unit not stores a paper ID of the newly mounted electronic paper, and
the registered data reception unit includes an ID transmission unit for transmitting the pad ID of the electronic pad apparatus and the paper ID of the electronic paper to the externally-connected server unit to correspond to the pad ID and the paper ID to each other when the data registration determination unit determines that the paper ID storage unit stores a paper ID of the electronic paper, the registered data reception unit receiving the content display data from the server unit in response to the transmission of the pad ID and the paper ID to the server unit using the ID transmission unit.

3. The electronic pad apparatus according to claim 1, further comprising:
a display data acquisition unit for acquiring display data of arbitrary content from an external device; and
an arbitrary data display control unit for displaying the display data of arbitrary content acquired by the display data acquisition unit on the mounted electronic paper.

4. The electronic pad apparatus according to claim 3, wherein the external device is a communication terminal unit capable of receiving different content items via a network, and
the display data acquisition unit makes a communication connection with the communication terminal unit to acquire display data of arbitrary content that is received by the communication terminal unit via the network.

5. The electronic pad apparatus according to claim 3, wherein the external device is a content server unit on the network, and
the display data acquisition unit makes a direct communication connection with the content server unit on the network to acquire display data of arbitrary content.

6. The electronic pad apparatus according to claim 1, further comprising a paper display determination unit for determining whether content is displayed on electronic paper detected by the paper detection unit,
wherein when the paper detection unit detects that electronic paper is newly mounted and the paper display determination unit determines that no content is displayed on the electronic paper, the data registration determination unit determines whether content display data corresponding to the pad ID of the electronic pad apparatus and a paper ID of the electronic paper is registered in the server unit.

7. The electronic pad apparatus according to claim 1, wherein whenever display data of different content is displayed on electronic paper detected by the paper detection unit, the display data registration unit transmits the display data to the externally-connected server unit to correspond to the pad ID of the electronic pad apparatus and a paper ID of the electronic paper and registers the pad ID, the paper ID and the display data to correspond to one another, and
when the registered data reception unit receives a plurality of items of content display data, the registered data display control unit displays content display data selected by a user operation on the newly mounted electronic paper.

8. The electronic pad apparatus according to claim 1, further comprising:
an operating position detection unit for detecting an operating position corresponding to a user operation on electronic paper detected by the paper detection unit; and
an additional overlay display control unit for laying and displaying data corresponding to a user operating position detected by the operating position detection unit on a corresponding position of the electronic paper as additional data.

9. The electronic pad apparatus according to claim 8, further comprising:
an additional data storage unit for storing the additional data laid and displayed on the electronic paper by the additional overlay display control unit to correspond to a paper ID of the electronic paper;
an additional presence/absence determination unit for determining whether the additional data storage unit stores additional data corresponding to the paper ID of the electronic paper when the registered data display control unit displays the content display data received by the registered data reception unit on the newly mounted electronic paper; and
an additional overlay redisplay control unit for when the additional presence/absence determination unit determines that additional data corresponding to the paper ID of the electronic paper is stored, reading the additional data and laying and redisplaying the additional data on electronic paper on which the content display data is displayed.

10. The electronic pad apparatus according to claim 9, wherein the additional data storage unit stores the additional data laid and displayed on the electronic paper by the additional overlay display control unit to correspond to a content ID of the content display data displayed on the electronic paper and the paper ID,
the additional presence/absence determination unit determines whether the additional data storage unit stores additional data corresponding to the content ID of the content display data displayed on the electronic paper and the paper ID when the registered data display control unit displays the content display data received by the registered data reception unit on the newly mounted electronic paper; and
when the additional presence/absence determination unit determines that additional data corresponding to the content ID of the content display data displayed on the electronic paper and the paper ID is stored, the additional overlay redisplay control unit reads the additional data and lays and redisplays the additional data on electronic paper on which content display data corresponding to a content ID of the additional data is displayed.

11. The electronic pad apparatus according to claim 1, further comprising a user ID input unit for inputting a user ID in accordance with a user operation,
wherein the display data registration unit transmits display data of arbitrary content displayed on the electronic paper detected by the paper detection unit to the externally-connected server unit and registers the display data to correspond to the user ID input by the user ID input unit, the pad ID of the electronic pad apparatus and the paper ID of the electronic paper,
when the paper detection unit detects that electronic paper is newly mounted, the data registration determination unit determines whether content display data corresponding to the user ID input by the user ID input unit, the pad ID of the electronic pad apparatus and a paper ID of the electronic paper is registered in the server unit, and
when the data registration determination unit determines that the content display data corresponding to the user ID, the pad ID of the electronic pad apparatus and the paper ID of the electronic paper is registered in the server unit, the registered data reception unit receives the content display data from the server unit.

12. A data management apparatus which manages display information of electronic paper detachably mounted on an electronic pad apparatus, the data management apparatus comprising:
a display information registration unit for registering a pad ID of the electronic pad apparatus, a paper ID of the electronic paper and content display data displayed on the electronic paper to correspond to one another;
a data reception unit for receiving the pad ID of the electronic pad apparatus and the paper ID of the electronic paper from the electronic pad apparatus;
a new registration unit for when the display information registration unit does not register a combination of the pad ID of the electronic pad apparatus and the paper ID of the electronic paper which are received by the data reception unit, new registration content display data received from the electronic pad apparatus in the display information registration unit to correspond to the combination of the pad ID and the paper ID;
an update registration unit for when the display information registration unit registers a combination of the pad ID of the electronic pad apparatus and the paper ID of the electronic paper which are received by the data reception unit and when the content display data registered to correspond to the combination of the pad ID and the paper ID differs from the content display data received from the electronic pad apparatus, updating the registered content display data to the received content display data and registering the updated content display data; and
a data transmission unit for when the display information registration unit registers a combination of the pad ID of the electronic pad apparatus and the paper ID of the electronic paper which are received by the data reception unit and when the content display data corresponding to the pad ID and the paper ID is not received, reading content display data registered to correspond to the pad ID and the paper ID and transmitting the content display data as data to be redisplayed on the electronic paper mounted on the electronic pad apparatus.

13. An electronic pad apparatus on which electronic paper is mounted detachably, comprising:
a paper detection unit for detecting that the electronic paper is mounted;
an additional overlay display control unit for laying and displaying data corresponding to a user operating position as additional data on display data of arbitrary content displayed on the electronic paper detected by the paper detection unit;
an additional data storage unit for storing the additional data laid and displayed on the display data displayed on the electronic paper by the additional overlay display control unit and its positional information to correspond to a content ID of the display data;
an additional presence/absence determination unit for determining whether the additional data storage unit stores additional data corresponding to the content ID of the display data displayed on the electronic paper when the paper detection unit detects that electronic paper is newly mounted; and
an additional overlay redisplay control unit for when the additional presence/absence determination unit determines that additional data corresponding to the content ID of the display data is stored, reading the additional data and the positional information and laying and redisplaying the additional data and the positional information in a corresponding position on the display data displayed on the electronic paper.

14. The electronic pad apparatus according to claim 13, further comprising an operating position detection unit for detecting an operating position corresponding to a user operation on the electronic paper detected by the paper detection unit,
wherein the additional overlay display control unit lays and displays data corresponding to the user operating position on the electronic paper, which is detected by the operating position detection unit, as additional data in a corresponding position on the display data displayed on the electronic paper.

15. The electronic pad apparatus according to claim 14, wherein the additional data storage unit stores the additional data laid and displayed on the display data displayed on the electronic paper by the additional overlay display control unit and its positional information in accordance with the user operating position on the electronic paper detected by the operating position detection unit.

16. The electronic pad apparatus according to claim 13, wherein when the paper detection unit detects that electronic paper is newly mounted, display data is displayed in advance on the newly mounted electronic paper.

17. The electronic pad apparatus according to claim 13, further comprising:
a display data registration unit for transmitting the display data of the arbitrary content displayed on the electronic paper detected by the paper detection unit to an externally-connected server unit and registering the display data to correspond to a pad ID of the electronic pad apparatus and a paper ID of the electronic paper;
an ID transmission unit for when the paper detection unit detects that electronic paper is newly mounted, transmitting the pad ID of the electronic pad apparatus and a paper ID of the newly mounted electronic paper to the server unit;
a registered data reception unit for receiving the display data which is registered in the server unit to correspond to the pad ID and paper ID transmitted by the ID transmission unit; and
a registered data display control unit for displaying the display data received by the registered data reception unit on the newly mounted electronic paper.

18. Electronic paper which is detachably mounted on an electronic pad to displaying display data of arbitrary content, the electronic paper comprising:
a pad detection unit for detecting that the electronic paper is mounted on the electronic pad;
an additional overlay display control unit for laying and displaying data corresponding to a user operating position as additional data on the display data of arbitrary content displayed on the electronic paper which is mounted on the electronic pad and detected by the pad detection unit;
an additional data storage unit for storing the additional data laid and displayed on the display data by the additional overlay display control unit and its positional information to correspond to the pad ID of the electronic pad detected by the pad detection unit;
an additional presence/absence determination unit for determining whether the additional data storage unit stores the additional data corresponding to the pad ID of the electronic pad when the pad detection unit detects that electronic paper is newly mounted on the electronic pad; and
an additional overlay redisplay control unit for when the additional presence/absence determination unit determines that the additional data corresponding to the pad ID of the electronic pad is stored, reading the additional data and the positional information and laying and redisplaying the additional data and the positional information in a corresponding position on the display data displayed on the electronic paper.

19. The electronic paper according to claim 18, wherein the additional data storage unit stores the additional data laid and displayed on the display data by the additional overlay display control unit and the positional information to correspond to the pad ID of the electronic pad detected by the pad detection unit and a content ID of the display data,
the additional presence/absence determination unit determines whether the additional data storage unit stores the additional data corresponding to the pad ID of the electronic pad and the content ID of the display data displayed on the electronic paper when the pad detection unit detects that electronic paper is newly mounted on the electronic pad, and
when the additional presence/absence determination unit determines that the additional data corresponding to the pad ID of the electronic pad and the content ID of the displayed display data is stored, the additional overlay redisplay control unit reads the additional data and the positional information and lays and redisplays the additional data and the positional information in a corresponding position on the displayed display data.

20. The electronic paper according to claim 19, wherein when the pad detection unit detects that electronic paper is newly mounted on the electronic pad, the electronic paper displays display data of arbitrary content in advance.

21. The electronic paper according to claim 19, further comprising:
a data reception unit for when the pad detection unit detects that the electronic paper is newly mounted on the electronic pad, receiving display data from the electronic pad; and
a data display control unit for displaying the display data received by the data reception unit on the electronic paper.

22. The electronic paper according to claim 18, further comprising a non-display control unit for when the pad detection unit detects which the electronic paper is detached from the electronic pad, changing a display state to a non-display state.

23. The electronic paper according to claim 22, wherein the non-display control unit changes the display state to the non-display state after a lapse of a given period time when the pad detection unit detects that the electronic paper is detached from the electronic pad.
